(19) United States
(12) Patent Application Publication
(10) Pub. No.: US 2026/0120631 A1
(43) Pub. Date: Apr. 30, 2026

(54) DISPLAY DEVICE, DISPLAY APPARATUS, PHOTOELECTRIC CONVERSION APPARATUS, ELECTRONIC APPARATUS, MOVING BODY, AND WEARABLE DEVICE

(71) Applicant: CANON KABUSHIKI KAISHA, Tokyo (JP)

(72) Inventor: YOTA ITO, Tokyo (JP)

(21) Appl. No.: 19/368,676

(22) Filed: Oct. 24, 2025

(30) Foreign Application Priority Data
Oct. 28, 2024 (JP) 2024-189197

(51) Int. Cl. G09G 3/3225; H04N 13/327; H04N 13/344

(52) U.S. Cl. CPC G09G 3/3225; H04N 13/344; G09G 2310/08; G09G 2320/0247; G09G 2320/0261; G09G 2360/141; H04N 13/327

(57) ABSTRACT

A display device is provided. The display device includes a pixel array, a driver configured to drive the pixel array, and a controller configured to control the driver. The controller is configured to control the driver such that each of a plurality of unit frame periods includes a plurality of sub-frame periods and a duty ratio in each sub-frame period is controlled, and in each unit frame period, a non-light-emitting state is set in at least one of an initial sub-frame period and a last sub-frame period.

### BACKGROUND

### Field of the Technology

The aspect of the embodiments relates to a display device, a display apparatus, a photoelectric conversion apparatus, an electronic apparatus, a moving body, and a wearable device.

### Description of the Related Art

Display devices are recently used for various application purposes and have been developed extensively in the field of compact displays mounted in portable devices. The display device performs a refresh operation of rewriting a video several ten to several hundred times per sec. As an index on the display device side for outputting a video, the frequency of the refresh operation is called a refresh rate. As for display on the display device, a video of a high refresh rate looks more natural. However, an increase in refresh rate increases the circuit scale of the display device and also increases power consumption during driving. On the other hand, if the refresh rate is low, video flickering called a flicker is visually recognized. Hence, the display device is normally used with a frequency of about 60 Hz or more at which flickers are hard to visually recognize.

A display device such as an organic EL (OLED) or a micro LED uses a self-emission type light-emitting element in each pixel, and applies a desired current to each light-emitting element, thereby causing it to emit light. Since the period to cause light emission corresponds to the current application period, the light-emitting period in one frame can be adjusted. The ratio of the light-emitting period to the period of one frame is called a duty ratio. If the duty ratio is 100% (if light emission is always performed), no flicker occurs in 60-Hz driving. However, in a video of quick motion, since the difference between two continuous frame videos is large, the videos are averaged by the after image effect of human vision, and a blurred video is recognized. The after image effect of vision is called a blur or a motion blur. Japanese Patent Laid-Open No. 2006-030516 describes a technique of suppressing flickers by dividing one frame into a plurality of sub-frames and causing light-emitting elements to emit light only during a light-emitting period according to the duty ratio for each sub-frame.

In the technique described in Japanese Patent Laid-Open No. 2006-030516, since the duty ratio does not change between sub-frames in a frame, the blur suppression effect may be insufficient in a video of quick motion even if duty driving is performed.

### SUMMARY

A display device comprising: a pixel array; a driver configured to drive the pixel array; and a controller configured to control the driver, wherein the controller is configured to control the driver such that each of a plurality of unit frame periods includes a plurality of sub-frame periods and a duty ratio in each sub-frame period is controlled, and in each unit frame period, a non-light-emitting state is set in at least one of an initial sub-frame period and a last sub-frame period, is provided.

Features of the disclosure will become apparent from the following description of embodiments with reference to the attached drawings. The following description of embodiments is described by way of example.

### BRIEF DESCRIPTION OF THE DRAWINGS

FIG. 1 is a view showing an example of the configuration of a display device according to an embodiment;

FIG. 2 is a timing chart showing an example of the operation of the display device shown in FIG. 1;

FIG. 3 is a block diagram showing an example of the configuration of the controller of the display device shown in FIG. 1;

FIG. 4 is a timing chart showing an example of the operation of the display device shown in FIG. 1;

FIG. 5 is a timing chart showing an example of the operation of the display device shown in FIG. 1;

FIG. 6 is a timing chart showing an example of the operation of the display device shown in FIG. 1;

FIG. 7 is a timing chart showing an example of the operation of the display device shown in FIG. 1;

FIG. 8 is a timing chart showing an example of the operation of the display device shown in FIG. 1;

FIG. 9 is a timing chart showing an example of the operation of the display device shown in FIG. 1;

FIG. 10 is a timing chart showing an example of the operation of the display device shown in FIG. 1;

FIG. 11 is a timing chart showing an example of the operation of the display device shown in FIG. 1;

FIG. 12 is a timing chart showing an example of the operation of the display device shown in FIG. 1;

FIG. 13 is a timing chart showing an example of the operation of the display device shown in FIG. 1;

FIG. 14 is a timing chart showing an example of the operation of the display device shown in FIG. 1;

FIG. 15 is a timing chart showing an example of the operation of the display device shown in FIG. 1;

FIG. 16 is a block diagram showing an example of the configuration of the controller of the display device shown in FIG. 1;

FIG. 17 is a timing chart showing an example of the operation of a display device including the controller shown in FIG. 16;

FIGS. 18A and 18B are sectional views showing an example of the configuration of a pixel of the display device shown in FIG. 1;

FIGS. 19A to 19C are views showing an example of an image forming apparatus using the display device according to the embodiment;

FIG. 20 is a view showing an example of a display apparatus using the display device according to the embodiment;

FIG. 21 is a view showing an example of a photoelectric conversion apparatus using the display device according to the embodiment;

FIG. 22 is a view showing an example of an electronic apparatus using the display device according to the embodiment;

FIGS. 23A and 23B are views each showing an example of a display apparatus using the display device according to the embodiment;

FIG. 24 is a view showing an example of an illumination apparatus using the display device according to the embodiment;

FIGS. 25A and 25B are views showing an example of a moving body using the display device according to the embodiment; and

FIGS. 26A and 26B are views each showing an example of a wearable device using the display device according to the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

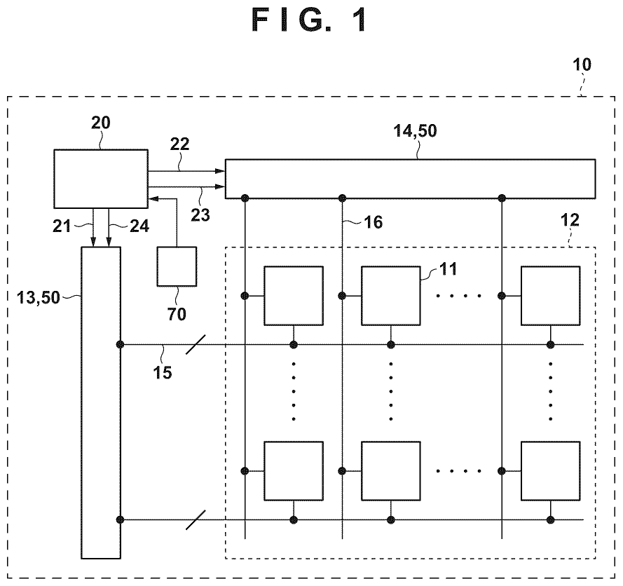

A light-emitting apparatus according to an embodiment of the disclosure will be described with reference to FIGS. 1 to 17. FIG. 1 is a view showing an example of the configuration of a display device 10 according to this embodiment. The display device 10 can include a pixel array 12, a vertical scanning circuit 13 and a signal output circuit 14 which serve as a driver 50 configured to drive the pixel array 12, and a controller 20 configured to drive the driver 50. It can be said that the vertical scanning circuit 13 and the signal output circuit 14 form the driver 50 configured to drive the pixel array 12. In the pixel array 12, a plurality of pixels 11 are arranged to form a plurality of rows and columns. The controller 20 can generate control signals for controlling the vertical scanning circuit 13 and the signal output circuit 14. The controller 20 can supply, for example, a scanning control signal 24 for vertical scanning and a light emission control signal 21 for controlling the duty ratio (a light-emitting period in another viewpoint) to the vertical scanning circuit 13. The duty ratio can be controlled for each sub-frame. The duty ratio can also be controlled to 0% (non-light-emitting state). The controller 20 can also supply a signal output control signal 22 and display image data 23 to the signal output circuit 14.

The vertical scanning circuit 13 can be configured to drive a plurality of scanning lines 15 extending in the row direction (the horizontal direction in FIG. 1). Each scanning line 15 can include a write control line and a drive signal line. Each pixel 11 can include a light-emitting element, a driving transistor that drives the light-emitting element in accordance with a luminance signal, a switch transistor that controls light emission/non-light emission of the light-emitting element, and a write transistor that writes a signal according to the luminance signal to the gate of the driving transistor. The luminance signal is a signal according to a luminance level at which each pixel 11 emits light. The luminance signal can be supplied from the signal output circuit 14 of the driver 50 to the write transistor via a signal line 16. The write control line can be connected to the gate of the write transistor, and the drive signal line can be connected to the gate of the switch transistor. A period in which a drive signal supplied to the drive signal line is active is the light-emitting period, and a period in which the drive signal supplied to the drive signal line is inactive is the non-light-emitting period. The vertical scanning circuit 13 controls the potential of the write control line of each row, that is, a write control signal in accordance with the scanning control signal 24.

The signal output circuit 14 digital/analog (D/A)-converts the display image data 23 sequentially sent from the controller 20, thus generates, as a luminance signal, a signal having a potential according to the value of the luminance level of the display image data 23, and outputs it to each signal line 16. The pixel 11 is arranged at the intersection between the scanning line 15 and the signal line 16, and the scanning line 15 and the signal line 16 are connected to the corresponding pixel 11.

The light-emitting element of the pixel 11 can be, for example, an Organic Light Emitting Diode (OLED). It is said that the light-emitting element of the pixel 11 can be an organic electroluminescence (EL) element. The transistor of the pixel 11, such as a driving transistor, a switch transistor, or a write transistor, can be, for example, a field effect transistor (FET). The OLED can be formed by, for example, sequentially stacking a hole injection layer, a hole transport layer, a light-emitting layer, an electron transport layer, an electron injection layer, and the like between an anode and a cathode, at least one of which is transparent.

In this embodiment, the controller 20 controls the driver 50 such that each unit frame period includes a plurality of sub-frame periods and the duty ratio in each sub-frame period is controlled. One unit frame period can be said as a period for generating one image on the pixel array 12. The controller 20 can control the driver 50 such that in each unit frame period, for example, a sub-frame period starts with a light-emitting period and includes a non-light-emitting period after the end of the light-emitting period. For example, the controller 20 can control the driver 50 such that in each unit frame, the duty ratio of at least the last sub-frame period becomes 0% (the non-light-emitting state is set in the last sub-frame period). In a case where the unit frame period is divided into two sub-frame periods, when the non-light-emitting state is set in the last sub-frame period, the unit frame period is divided into one light-emitting period and one non-light-emitting period as a whole. Therefore, this is different from a method of dividing one unit frame period into a plurality of sub-frame periods. In addition, dividing the unit frame period into two sub-frame periods may be inappropriate from the viewpoint of suppression of a flicker. Therefore, in this embodiment, each unit frame period includes n sub-frame periods where n is 3 or more. The controller 20 can control the driver 50 such that in a case where the unit frame period is divided into n sub-frame periods where n is 3 or more, the non-light-emitting state is set in the sub-frame periods from a sub-frame period m to a sub-frame period n (last sub-frame period) where 2≤m≤n. In this embodiment, since the controller 20 always sets the non-light-emitting state for the nth sub-frame period, the number of times of light emission during the unit frame period is n−1 or less. The controller 20 can control the driver 50 such that in each unit frame period, the length from the end of the light-emitting period of a last sub-frame period m−1 including the light-emitting period to the end of the unit frame period is 3 millisecond (msec, ms) or more.

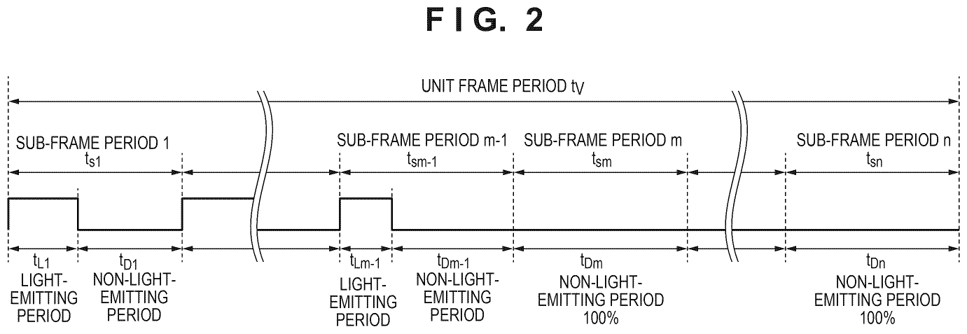

FIG. 2 exemplarily shows the operation of the display device 10 according to this embodiment in one unit frame period t_{V}. The unit frame period t_{V} is also called one vertical scanning period or simply a frame period. To each pixel 11 arranged in the pixel array 12, at a rate of once in one unit frame period, a luminance signal can be supplied and a signal according to the luminance signal can be written.

The display device 10 can be, for example, a self-emission type display device including an OLED as a light-emitting element, as described above. The light-emitting element may be a micro LED. The self-emission type display device 10 is excellent because of its high refresh rate, as compared to a display device that is not of a self-emission type such as a liquid crystal display (LCD).

The display device 10 can form a display apparatus together with a power supply, a control circuit such as a video controller and an operation controller, and the like. The display apparatus may be formed as, for example, a smartphone, a monitor display, a Cross Reality (XR) device, an electro view finder (EVF), a monocle, binocular glasses, or night vision goggles, regardless of portable/nonportable device. In addition, the display apparatus may use a display device of any size. An optical system such as a lens may be arranged between the display device and eyes.

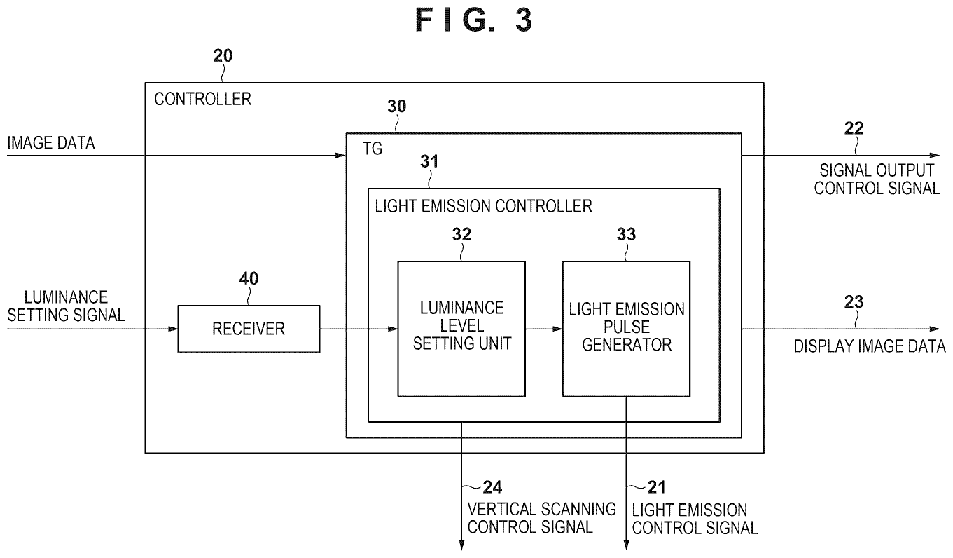

FIG. 3 shows an example of the configuration of the controller 20. FIG. 3 is a view with attention paid on generation of the light emission control signal 21, and generation of the signal output control signal 22, the display image data 23, and the scanning control signal 24 can comply with known techniques. The controller 20 can include a timing generator (TG) 30 and a receiver 40. The receiver 40 can receive a luminance setting signal and supply it to the TG 30. The TG 30 can receive image data supplied from the outside of the display device 10 and a synchronization signal (not shown), and generate the signal output control signal 22, the display image data 23, and the scanning control signal 24. The TG 30 can include a light emission controller 31 that generates the light emission control signal 21 (light emission pulse) in accordance with the luminance setting signal supplied from the receiver 40. The light emission controller 31 can include, for example, a luminance level setting unit 32 and a light emission pulse generator 33.

The display apparatus including the display device 10 can include an interface (for example, physical buttons or a Graphical User Interface (GUI)) configured to set the luminance of the display device 10. If the luminance is changed by a user operating the interface, the luminance setting signal can be supplied to the controller 20 (receiver 40) of the display device 10. When the receiver 40 receives the luminance setting signal and supplies it to the TG 30, the luminance level setting unit 32 of the TG 30 sets the luminance and the duty ratio in each unit frame period. The light emission pulse generator 33 can generate the light emission control signal 21 (pulse signal) that defines a light-emitting period and a non-light-emitting period of each pixel 11 in accordance with the duty ratio set by the luminance level setting unit 32. The TG 30 can generate the display image data 23 in accordance with the luminance and the image data set by the luminance level setting unit 32.

The controller 20 (the TG 30 or the light emission pulse generator 33 in another viewpoint) can generate the light emission control signal 21 such that one unit frame period of image data is divided into a plurality of (in other words, n) sub-frame periods. Each of the plurality of sub-frame periods may be a period obtained by temporally evenly dividing one unit frame period. As shown in FIG. 2, the light-emitting period of sub-frame period 1 that is the first sub-frame period is expressed as t_{L1}, and the non-light-emitting period as t_{D1}. Similarly, the light-emitting period of a kth (k is an integer, 1≤k≤n) sub-frame period k is expressed as t_{Lk}, and the non-light-emitting period as t_{Dk}. If one unit frame period is temporally evenly divided into a plurality of sub-frame periods, t_{L1}+t_{D1}=t_{L2}+t_{D2}= . . . =t_{Ln}+t_{Dn}. Furthermore, in this embodiment, the light-emitting period of the last sub-frame period n is t_{Ln}=0, and the last sub-frame period n is the period of the non-light-emitting state in which the pixel 11 emits no light. However, depending on the relationship between the timing setting of image data displayed by the display device 10 and the number n of divisions of one unit frame period (the total number of sub-frame periods), it may be difficult to completely evenly divide one unit frame period (set t_{L1}+t_{D1}=t_{L2}+t_{D2}= . . . =t_{Ln}+t_{Dn}). In this case as well, it is possible to implement the operation of the display device according to the disclosure. However, in the sub-frame period obtained by evenly dividing one unit frame period, control by the controller 20 can be simplified more.

The operation of display device 10 according to this embodiment will exemplarily be described below using several operation examples.

### Operation Example 1-1

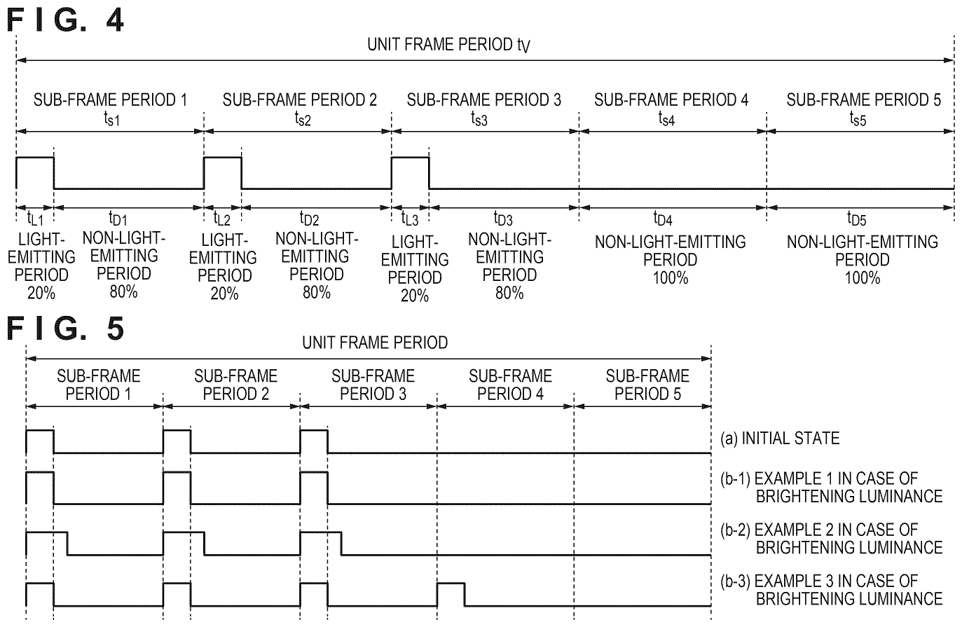

In this operation example, the refresh rate of the display device 10 is set to 60 Hz. Furthermore, in this operation example, as shown in FIG. 4, one unit frame period of image data of 60 frames per second (fps) is formed by five sub-frame periods. In this operation example, the controller 20 (light emission controller 31) controls the driver 50 (vertical scanning circuit 13) such that in each unit frame period, the non-light-emitting state is set in last sub-frame period 5. Furthermore, the controller 20 controls the driver 50 such that in a sub-frame period including a light-emitting period among the plurality of sub-frame periods, the sub-frame period starts with the light-emitting period. Next, the controller 20 controls the driver 50 such that in the sub-frame period including the light-emitting period among the plurality of sub-frame periods, the non-light-emitting period is set after the end of the light-emitting period. In the example shown in FIG. 4, sub-frame periods from first sub-frame period 1 to sub-frame period 3 each include the light-emitting period. Sub-frame period 4 and last sub-frame period 5 are sub-frame periods in which the non-light-emitting state with a duty ratio of 0% is set (no light-emitting period is included).

As shown in FIG. 2, in a case where each unit frame period is divided into n sub-frame periods where n is 3 or more, the non-light-emitting state is set in the sub-frame periods from the sub-frame period m to the last sub-frame period n where 2≤m≤n. Therefore, t_{Dend}=t_{Dm-1}+tₛₘ+ . . . tₛₙ is satisfied where t_{Dend} represents the length of the last non-light-emitting period in each unit frame period, tₛₖ represents the length of the sub-frame period k, and t_{Dk} represents the length of the non-light-emitting period in the sub-frame period k. For m=2, the light-emitting period is t_{L1} of sub-frame period 1 (t_{L2}= . . . =t_{Ln}=0), and it may thus be inappropriate to constantly set m=2 from the viewpoint of suppression of a flicker. However, as will be described later, m=2 may be temporarily set for the purpose of adjusting the luminance or the like. When m is 3 or more, t_{Dr}<t_{Dend} (r is an integer, 1≤r≤m−2) may be satisfied in order to improve the blur suppression effect. For example, in the operation shown in FIG. 4, the plurality of sub-frame periods include one or more sub-frame periods 1 to 3 each including the light-emitting period, and one or more sub-frame periods 4 and 5 including last sub-frame period 5 without the light-emitting period. In this case, the controller 20 may control the driver 50 such that each unit frame period includes sub-frame periods 4 and 5 without the light-emitting period after sub-frame periods 1 to 3 each including the light-emitting period. In other words, the longest non-light-emitting period in each unit frame period is set to the end of the unit frame period. That is, the controller 20 controls the driver 50 such that in each unit frame period, the length from the end of the light-emitting period in the last sub-frame period among the sub-frame periods each including the light-emitting period to the end of the unit frame period is longer than the length of the non-light-emitting period in each sub-frame period including the light-emitting period. Thus, the period to change the display image data between two continuous unit frame periods becomes long, thereby making it possible to improve the blur suppression effect.

When t_{V} represents one unit frame period, in this operation example, m=4 and n=5, thereby satisfying t_{Dend}=t_{D3}+tₛ₄+tₛ₅. Since t_{D1}=t_{D2}, t_{Dr}<t_{Dend} (r=1, 2) is satisfied. In this operation example, t_{Dend}=12.7 msec is obtained.

As described above, the controller 20 (light emission controller 31) controls the driver 50 (vertical scanning circuit 13) such that in each unit frame period, the duty ratio of at least the last sub-frame period is 0% (the non-light-emitting state is set in the last sub-frame period). Since each unit frame period is divided into five sub-frame periods with a refresh rate of 60 Hz, the apparent refresh rate is 300 Hz. In driving at 300 Hz, flickers are hardly visually recognized, and it can thus be said in this operation example that flickers are suppressed. If driving is performed at a duty ratio of 20% in all the sub-frame periods, the non-light-emitting period immediately before switching to the next unit frame period (for example, switching of the display image data) is 2.7 msec. In contrast, in this operation example, the non-light-emitting period immediately before switching to the next unit frame period is as long as 12.7 msec. When the non-light-emitting period immediately before switching of the display image data is long, it is possible to suppress a blur caused by averaging the videos by the after image effect of human vision.

It is found, as a result of examinations, that when the non-light-emitting period is provided after the light-emitting period in the sub-frame period, to suppress blurs, a higher blur suppression effect can be obtained if the period to change the display image data between two continuous frame periods is 3 msec or more. The period to change the display image data between two continuous unit frame periods is the period from the end of the light-emitting period of the last sub-frame period including the light-emitting period to the start of light emission in the first sub-frame period of the next unit frame period. More specifically, if a period in which a vertical synchronization signal is invalid between two continuous unit frame periods is indicated by t_{vsoff}, t_{Dend}+t_{vsoff}≥3 msec can be satisfied. However, in the display device 10, since t_{vsoff} is in the 0.01 msec order (t_{vsoff}<<3 msec), control can be performed to satisfy t_{Dend}≥3 msec. That is, the controller 20 may control the driver 50 such that in each unit frame period, the length from the end of the light-emitting period in the last sub-frame period among the sub-frame periods each including the light-emitting period to the end of the unit frame period is 3 msec or more.

If the non-light-emitting state is set in the last sub-frame period, control may be performed such that each sub-frame period starts with the non-light-emitting period and includes the light-emitting period after the end of the non-light-emitting period. However, the period of t_{Dend} can be made longer by performing control such that each sub-frame period starts with the light-emitting period and includes the non-light-emitting period after the end of the light-emitting period.

If t_{Dr}<t_{Dend} (r is an integer, 1≤r≤m−2) is satisfied, it is unnecessary to temporally evenly divide one frame period into a plurality of sub-frame periods. That is, at least t_{D1}<t_{Dend}=t_{Dn-1}+tₛₙ is satisfied, but control is simplified by satisfying t_{Dr}<tₛₙ. In addition, since tₛᵣ=t_{Lr}+t_{Dr} and thus t_{Dr}<tₛᵣ is satisfied, t_{Dr}<t_{Dend} is always satisfied when tₛᵣ=tₛₙ. Therefore, to implement blur suppression and simplification of control by the controller 20, one unit frame period may be evenly divided into a plurality of sub-frame periods.

In this operation example, if the user is going to change the luminance setting, the receiver 40 receives luminance setting information and sends a signal to the luminance level setting unit 32. If the user is going to make the luminance high (increase brightness), setting by the luminance level setting unit 32 can be done in accordance with a driving example shown in FIG. 5. FIG. 5 shows, as (a) initial state, the same driving as the driving shown in FIG. 4. In contrast, in (b-1), the luminance is made high by increasing the intensity (potential) of the light emission pulse of the luminance signal. In (b-2), the luminance is made high by lengthening the light-emitting period of the sub-frame period (increasing the duty ratio). In (b-3), the luminance is made high by decreasing the number of sub-frame periods in which the non-light-emitting state is set (the duty ratio is 0%) (in this operation example, the duty ratio of sub-frame period 4 is also set to 20%).

In the driving method of controlling the duty ratio (duty driving), the method of making the luminance high by increasing the intensity of the light emission pulse, like (b-1), is sometimes inappropriate. Examples are a case where the light emission efficiency of a light-emitting element does not rise even if the potential of the luminance signal is increased and a case where there is a restriction by a maximum voltage suppliable to a light-emitting element. In (b-3), if, in the initial state, there is one sub-frame period in which the non-light-emitting state is set, the non-light-emitting state is to be set in at least the last sub-frame period in this operation example, change cannot be made. Although there may be a restriction to make the luminance high, the luminance setting may be changed by combining (b-1), (b-2), and (b-3) in any case. By setting the luminance by combining (b-1), (b-2), and (b-3), it is possible to set the luminance to almost any luminance value.

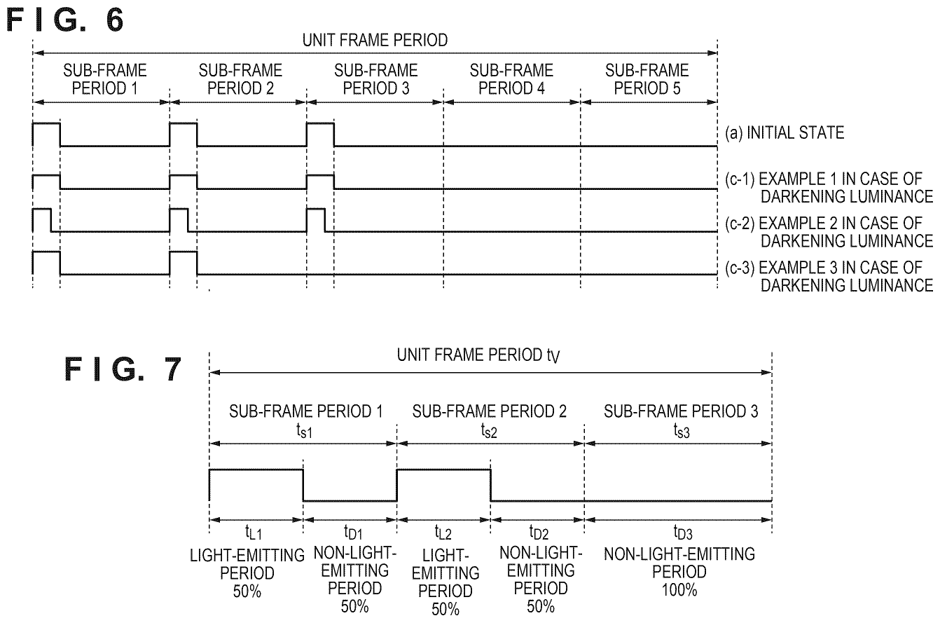

Similarly, if the user is going to make the luminance low (decrease brightness), setting by the luminance level setting unit 32 can be done in accordance with a driving example shown in FIG. 6. In (c-1), the luminance is made low by decreasing the intensity (potential) of the light emission pulse of the luminance signal. In (c-2), the luminance is made low by shortening the light-emitting period of the sub-frame period (decreasing the duty ratio). In (c-3), the luminance is made low by increasing the number of sub-frame periods in which the non-light-emitting state is set (the duty ratio is 0%) (in this operation example, the non-light-emitting state is also set in sub-frame period 3).

In the setting of (c-3), in one embodiment, if there are only two sub-frame periods each including the light-emitting period in the initial state, when the number of sub-frame periods in which the non-light-emitting state is set is increased, only sub-frame period 1 includes the light-emitting period. This is equivalent to that the unit frame period is not substantially formed by a plurality of sub-frame periods and duty driving is performed. Depending on the setting of the refresh rate, attention is required from the viewpoint of flicker suppression. Although there may be a restriction to make the luminance low, the luminance setting may be changed by combining (c-1), (c-2), and (c-3) in any case. By setting the luminance by combining (c-1), (c-2), and (c-3), it is possible to set the luminance to almost any luminance value.

### Operation Example 1-2

In this operation example, the refresh rate of the display device 10 is set to 60 Hz. Furthermore, in this operation example, as shown in FIG. 7, one unit frame period of image data of 60 fps is formed by three sub-frame periods. In this operation example as well, as described above, the controller 20 (light emission controller 31) controls the driver 50 (vertical scanning circuit 13) such that in each unit frame period, the non-light-emitting state is set in last sub-frame period 3. Furthermore, the controller 20 controls the driver 50 such that in a sub-frame period including a light-emitting period among the plurality of sub-frame periods, the sub-frame period starts with the light-emitting period, and then controls the driver 50 such that the non-light-emitting period is set after the end of the light-emitting period. In the example shown in FIG. 7, first sub-frame period 1 and sub-frame period 2 are sub-frame periods each including the light-emitting period. Last sub-frame period 3 is a sub-frame period in which the non-light-emitting state with a duty ratio of 0% is set (no light-emitting period is included).

Since each unit frame period is divided into three sub-frame periods with a refresh rate of 60 Hz, the apparent refresh rate is 180 Hz. In driving at 180 Hz, flickers are hardly visually recognized, and it can thus be said in this operation example that flickers are suppressed. If driving is performed at a duty ratio of 50% in all the sub-frame periods, the non-light-emitting period immediately before switching to the next unit frame period (for example, switching of the display image data) is 2.8 msec. In contrast, in this operation example, the non-light-emitting period immediately before switching to the next unit frame period is as long as 8.3 msec (t_{Dend}=8.3 msec). When the non-light-emitting period immediately before switching of the display image data is long, it is possible to suppress a blur caused by averaging the videos by the after image effect of human vision.

In this operation example as well, if the user is going to change the luminance setting, it is possible to change the luminance setting by the same method as that described above with reference to FIG. 5 or 6.

### Operation Example 1-3

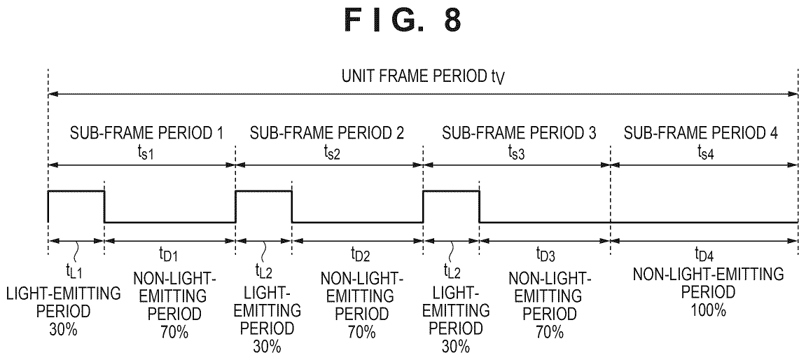

In this operation example, the refresh rate of the display device 10 is set to 60 Hz. Furthermore, in this operation example, as shown in FIG. 8, one unit frame period of image data of 60 fps is formed by four sub-frame periods. In this operation example as well, as described above, the controller 20 (light emission controller 31) controls the driver 50 (vertical scanning circuit 13) such that in each unit frame period, the non-light-emitting state is set in last sub-frame period 4. Furthermore, the controller 20 controls the driver 50 such that in a sub-frame period including a light-emitting period among the plurality of sub-frame periods, the sub-frame period starts with the light-emitting period and then controls the driver 50 such that the non-light-emitting period is set after the end of the light-emitting period. In the example shown in FIG. 8, sub-frame periods from first sub-frame period 1 to sub-frame period 3 each include the light-emitting period. Last sub-frame period 4 is a sub-frame period in which the non-light-emitting state with a duty ratio of 0% is set (no light-emitting period is included).

Since each unit frame period is divided into four sub-frame periods with a refresh rate of 60 Hz, the apparent refresh rate is 240 Hz. In driving at 240 Hz, flickers are hardly visually recognized, and it can thus be said in this operation example that flickers are suppressed. If driving is performed at a duty ratio of 30% in all the sub-frame periods, the non-light-emitting period immediately before switching to the next unit frame period (for example, switching of the display image data) is 2.9 msec. In contrast, in this operation example, the non-light-emitting period immediately before switching to the next unit frame period is as long as 7.1 msec (t_{Dend}=7.1 msec). When the non-light-emitting period immediately before switching of the display image data is long, it is possible to suppress a blur caused by averaging the videos by the after image effect of human vision.

In this operation example as well, if the user is going to change the luminance setting, it is possible to change the luminance setting by the same method as that described above with reference to FIG. 5 or 6.

### Operation Example 1-4

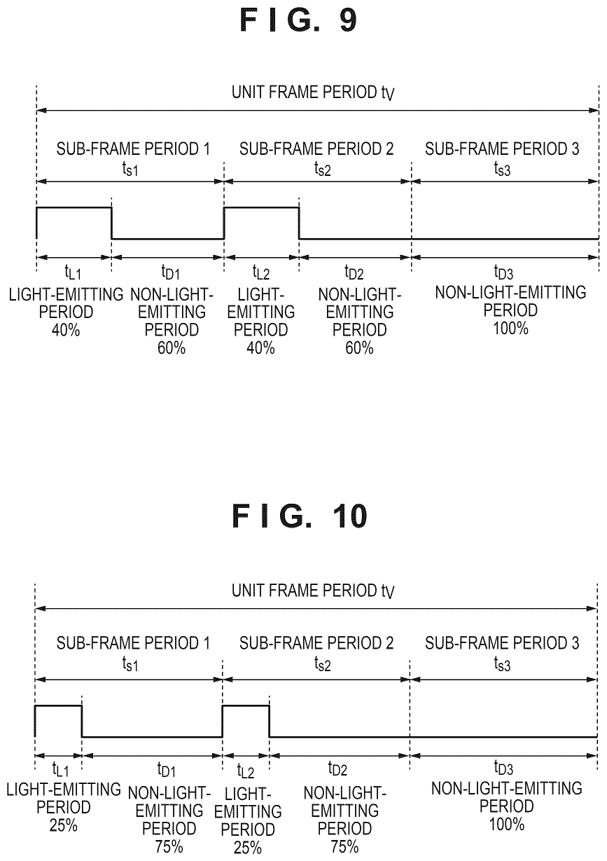

In this operation example, the refresh rate of the display device 10 is set to 72 Hz. Furthermore, in this operation example, as shown in FIG. 9, one unit frame period of image data of 72 fps is formed by three sub-frame periods. In this operation example as well, as described above, the controller 20 (light emission controller 31) controls the driver 50 (vertical scanning circuit 13) such that in each unit frame period, the non-light-emitting state is set in last sub-frame period 3. Furthermore, the controller 20 controls the driver 50 such that in a sub-frame period including a light-emitting period among the plurality of sub-frame periods, the sub-frame period starts with the light-emitting period, and then controls the driver 50 such that the non-light-emitting period is set after the end of the light-emitting period. In the example shown in FIG. 9, first sub-frame period 1 and sub-frame period 2 are sub-frame periods each including the light-emitting period. Last sub-frame period 3 is a sub-frame period in which the non-light-emitting state with a duty ratio of 0% is set (no light-emitting period is included).

Since each unit frame period is divided into three sub-frame periods with a refresh rate of 72 Hz, the apparent refresh rate is 216 Hz. In driving at 216 Hz, flickers are hardly visually recognized, and it can thus be said in this operation example that flickers are suppressed. If driving is performed at a duty ratio of 40% in all the sub-frame periods, the non-light-emitting period immediately before switching to the next unit frame period (for example, switching of the display image data) is 2.8 msec. In contrast, in this operation example, the non-light-emitting period immediately before switching to the next unit frame period is as long as 7.4 msec (t_{Dend}=7.4 msec). When the non-light-emitting period immediately before switching of the display image data is long, it is possible to suppress a blur caused by averaging the videos by the after image effect of human vision.

In this operation example as well, if the user is going to change the luminance setting, it is possible to change the luminance setting by the same method as that described above with reference to FIG. 5 or 6.

### Operation Example 1-5

In this operation example, the refresh rate of the display device 10 is set to 90 Hz. Furthermore, in this operation example, as shown in FIG. 10, one unit frame period of image data of 90 fps is formed by three sub-frame periods. In this operation example as well, as described above, the controller 20 (light emission controller 31) controls the driver 50 (vertical scanning circuit 13) such that in each unit frame period, the non-light-emitting state is set in last sub-frame period 3. Furthermore, the controller 20 controls the driver 50 such that in a sub-frame period including a light-emitting period among the plurality of sub-frame periods, the sub-frame period starts with the light-emitting period, and then controls the driver 50 such that the non-light-emitting period is set after the end of the light-emitting period. In the example shown in FIG. 10, first sub-frame period 1 and sub-frame period 2 are sub-frame periods each including the light-emitting period. Last sub-frame period 3 is a sub-frame period in which the non-light-emitting state with a duty ratio of 0% is set (no light-emitting period is included).

Since each unit frame period is divided into three sub-frame periods with a refresh rate of 90 Hz, the apparent refresh rate is 270 Hz. In driving at 270 Hz, flickers are hardly visually recognized, and it can thus be said in this operation example that flickers are suppressed. If driving is performed at a duty ratio of 25% in all the sub-frame periods, the non-light-emitting period immediately before switching to the next unit frame period (for example, switching of the display image data) is 2.8 msec. In contrast, in this operation example, the non-light-emitting period immediately before switching to the next unit frame period is as long as 6.8 msec (t_{Dend}=6.8 msec). When the non-light-emitting period immediately before switching of the display image data is long, it is possible to suppress a blur caused by averaging the videos by the after image effect of human vision.

In this operation example as well, if the user is going to change the luminance setting, it is possible to change the luminance setting by the same method as that described above with reference to FIG. 5 or 6.

### Operation Example 1-6

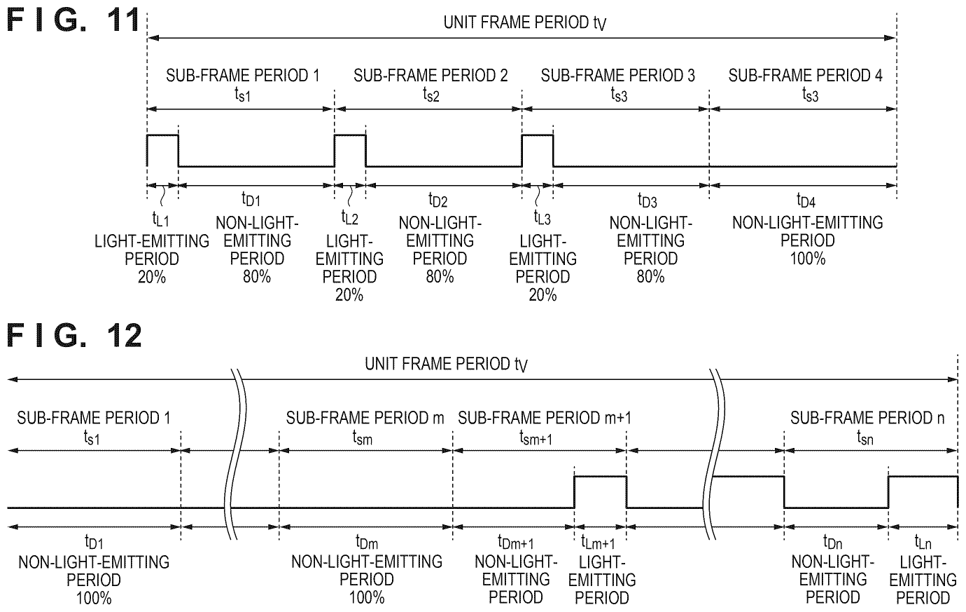

In this operation example, the refresh rate of the display device 10 is set to 120 Hz. Furthermore, in this operation example, as shown in FIG. 11, one unit frame period of image data of 120 fps is formed by four sub-frame periods. In this operation example as well, as described above, the controller 20 (light emission controller 31) controls the driver 50 (vertical scanning circuit 13) such that in each unit frame period, the non-light-emitting state is set in last sub-frame period 4. Furthermore, the controller 20 controls the driver 50 such that in a sub-frame period including a light-emitting period among the plurality of sub-frame periods, the sub-frame period starts with the light-emitting period, and then controls the driver 50 such that the non-light-emitting period is set after the end of the light-emitting period. In the example shown in FIG. 11, sub-frame periods from first sub-frame period 1 to sub-frame period 3 each include the light-emitting period. Last sub-frame period 4 is a sub-frame period in which the non-light-emitting state with a duty ratio of 0% is set (no light-emitting period is included).

Since each unit frame period is divided into four sub-frame periods with a refresh rate of 120 Hz, the apparent refresh rate is 480 Hz. In driving at 480 Hz, flickers are hardly visually recognized, and it can thus be said in this operation example that flickers are suppressed. If driving is performed at a duty ratio of 20% in all the sub-frame periods, the non-light-emitting period immediately before switching to the next unit frame period (for example, switching of the display image data) is 1.7 msec. In contrast, in this operation example, the non-light-emitting period immediately before switching to the next unit frame period is as long as 5.8 msec (t_{Dend}=5.8 msec). When the non-light-emitting period immediately before switching of the display image data is long, it is possible to suppress a blur caused by averaging the videos by the after image effect of human vision.

In this operation example as well, if the user is going to change the luminance setting, it is possible to change the luminance setting by the same method as that described above with reference to FIG. 5 or 6.

A modification of the above-described embodiment will be described next. The above-described embodiment has explained that the controller 20 controls the driver 50 such that in each unit frame period, the non-light-emitting state is set in the last sub-frame period. It has also been explained that the controller 20 controls the driver 50 such that in a sub-frame period including a light-emitting period among the plurality of sub-frame periods, the sub-frame period starts with the non-light-emitting period. However, the operation of the display device 10 is not limited to this. Points different from the above-described embodiment will mainly be described below, and a description of components and operations that may be the same as in the above-described embodiment will be omitted appropriately.

In this embodiment, the controller 20 can control the driver 50 such that in each unit frame period, for example, the sub-frame period starts with the non-light-emitting period and the light-emitting period is set after the end of the non-light-emitting period. Furthermore, for example, the controller 20 can control the driver such that in each unit frame period, the duty ratio of at least the first sub-frame period is 0% (the non-light-emitting state is set in the first sub-frame period).

The controller 20 can control the driver 50 such that in each unit frame period, if the unit frame period is divided into n sub-frame periods where n is 3 or more, the non-light-emitting state is set in sub-frame periods from sub-frame period 1 (first sub-frame period) to the sub-frame period m where 1≤m<n. Since the controller 20 always sets the non-light-emitting state in sub-frame period 1, the number of times of light emission during the unit frame period is n−1 or less. The controller 20 can control the driver 50 such that in each unit frame period, the length from the start of the unit frame period to the start of the light-emitting period of the first sub-frame period m including the light-emitting period is 3 msec or more.

FIG. 12 exemplarily shows the operation of the display device 10 according to this embodiment in one unit frame period t_{V}. Since the non-light-emitting state is set in at least the first sub-frame period among the plurality of sub-frame periods forming each unit frame period, the light-emitting period of the first sub-frame period is t_{L1}=0%.

The controller 20 (the TG 30 or the light emission pulse generator 33 in another viewpoint) can generate the light emission control signal 21 such that one unit frame period of image data is divided into a plurality of (in other words, n) sub-frame periods. Each of the plurality of sub-frame periods may be a period obtained by temporally evenly dividing one unit frame period. As shown in FIG. 12, the non-light-emitting period of sub-frame period 1 that is the first sub-frame period is expressed as t_{D1}, and the light-emitting period as t_{L1}. Similarly, the non-light-emitting period of the kth (k is an integer, 1≤k≤n) sub-frame period k is expressed as t_{Dk}, and the light-emitting period as t_{Lk}. If one unit frame period is temporally evenly divided into a plurality of sub-frame periods, t_{D1}+t_{L1}=t_{D2}+t_{L2}= . . . =t_{Dn}+t_{Ln}. Furthermore, in this embodiment, as described above, the light-emitting period of first sub-frame period 1 is t_{L1}=0. However, depending on the relationship between the timing setting of image data displayed by the display device 10 and the number n of divisions of one unit frame period (the total number of sub-frame periods), it may be difficult to completely evenly divide one unit frame period (set t_{D1}+t_{L1}=t_{D2}+t_{L2}= . . . =t_{Dn}+t_{Ln}). However, in the sub-frame period obtained by evenly dividing one unit frame period, control by the controller 20 can be simplified more.

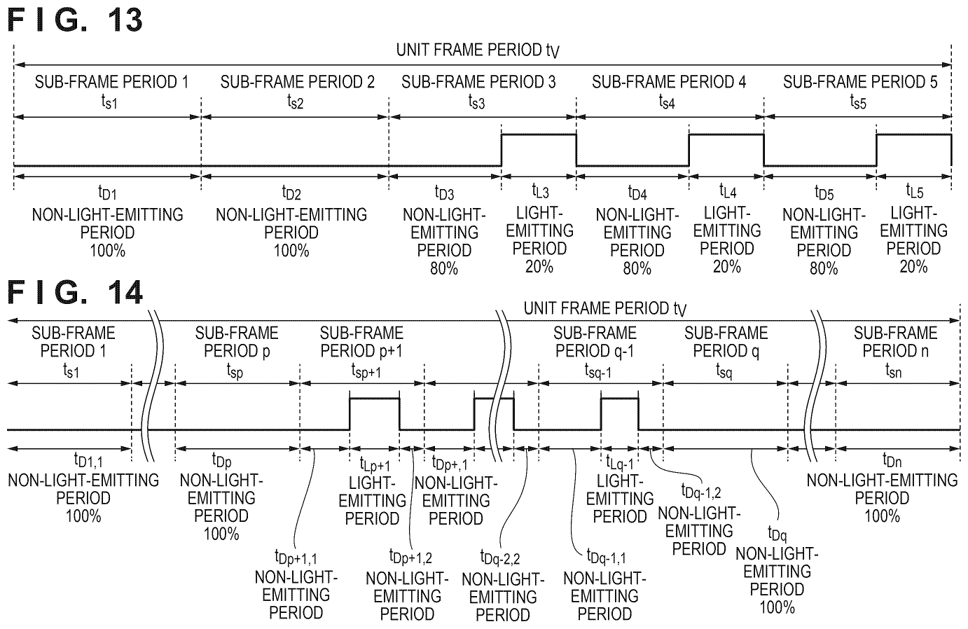

Next, the operation of display device 10 according to this embodiment will exemplarily be described. In this operation example, the refresh rate of the display device 10 is set to 60 Hz. Furthermore, in this operation example, as shown in FIG. 13, one unit frame period of image data of 60 fps is formed by five sub-frame periods. In this operation example, the controller 20 (light emission controller 31) controls the driver 50 (vertical scanning circuit 13) such that in each unit frame period, the non-light-emitting state is set in first sub-frame period 1. Furthermore, the controller 20 controls the driver 50 such that in a sub-frame period including a light-emitting period among the plurality of sub-frame periods, the sub-frame period starts with the non-light-emitting period. Next, the controller 20 controls the driver 50 such that in the sub-frame period including the light-emitting period among the plurality of sub-frame periods, the light-emitting period is set after the end of the non-light-emitting period. In the example shown in FIG. 13, first sub-frame period 1 and sub-frame period 2 are sub-frame periods in which the non-light-emitting state with a duty ratio of 0% is set (no light-emitting period is included). Sub-frame periods from sub-frame period 3 to last sub-frame period 5 each include the light-emitting period.

As shown in FIG. 12, in a case where each unit frame period is divided into n sub-frame periods where n is 3 or more, the non-light-emitting state is set in the sub-frame periods from sub-frame period 1 to the sub-frame period m where 1≤m≤n. Therefore, t_{Dini}=tₛ₁+ . . . tₛₘ+t_{Dm+1} is satisfied where t_{Dini} represents the length of the first non-light-emitting period in each unit frame period, tₛₖ represents the length of the sub-frame period k, and t_{Dk} represents the length of the non-light-emitting period in the sub-frame period k. For m=n−1, the light-emitting period is t_{L1} of the sub-frame period n (t_{L1}= . . . =t_{Ln-1}=0), and it may thus be inappropriate to constantly set m=n−1 from the viewpoint of suppression of a flicker. However, as described above, m=n−1 may be temporarily set for the purpose of adjusting the luminance or the like. When m is n−2 or less, t_{Dr}<t_{Dini} (r is an integer, m+1≤r≤n) may be satisfied in order to improve the blur suppression effect. For example, in the operation shown in FIG. 13, the plurality of sub-frame periods include one or more sub-frame periods 3 to 5 each including the light-emitting period, and one or more sub-frame periods 1 and 2 including first sub-frame period 1 without the light-emitting period. In this case, the controller 20 may control the driver 50 such that each unit frame period includes sub-frame periods 3 to 5 each including the light-emitting period after sub-frame periods 1 and 2 without the light-emitting period. In other words, the longest non-light-emitting period in each unit frame period is set to the beginning of the unit frame period. That is, the controller 20 controls the driver 50 such that in each unit frame period, the length from the start of the unit frame period to the start of the light-emitting period in the first sub-frame period among the sub-frame periods each including the light-emitting period is longer than the length of the non-light-emitting period in each sub-frame period including the light-emitting period. Thus, the period to change the display image data between two continuous unit frame periods becomes long, thereby making it possible to improve the blur suppression effect.

When t_{V} represents one unit frame period, in this operation example, m=2 and n=5, thereby satisfying t_{Dini}=tₛ₁+tₛ₂+tₛ₃. Since t_{D4}=t_{D5}, t_{Dr}<t_{Dend} (r=4, 5) is satisfied. In this operation example, t_{Dini}=12.7 msec is obtained.

As described above, the controller 20 (light emission controller 31) controls the driver 50 (vertical scanning circuit 13) such that in each unit frame period, the duty ratio of at least the first sub-frame period is 0% (the non-light-emitting state is set in the first sub-frame period). Since each unit frame period is divided into five sub-frame periods with a refresh rate of 60 Hz, the apparent refresh rate is 300 Hz. In driving at 300 Hz, flickers are hardly visually recognized, and it can thus be said in this operation example that flickers are suppressed. If driving is performed at a duty ratio of 20% in all the sub-frame periods, the non-light-emitting period immediately after switching to the current unit frame period (for example, switching of the display image data) is 2.7 msec. In contrast, in this operation example, the non-light-emitting period immediately after switching to the current unit frame period is as long as 12.7 msec. When the non-light-emitting period immediately after switching of the display image data is long, it is possible to suppress a blur caused by averaging the videos by the after image effect of human vision.

As described above, it is found that to suppress blurs, a higher suppression effect can be obtained if the period to change the display image data between two continuous frame periods is 3 msec or more. The period to change the display image data between two continuous unit frame periods is the period from the end of the light-emitting period of the last sub-frame period to the start of light emission in the first sub-frame period including the light-emitting period of the next unit frame period. More specifically, if a period in which a vertical synchronization signal is invalid between two continuous unit frame periods is indicated by t_{vsoff}; t_{vsoff}+t_{Dini}≥3 msec can be satisfied. However, in the display device 10, since t_{vsoff} is in the 0.01 msec order (t_{vsoff}<<3 msec), control can be performed to satisfy t_{Dini}≥3 msec. That is, the controller 20 may control the driver 50 such that in each unit frame period, the length from the start of the unit frame period to the start of the light-emitting period in the first sub-frame period among the sub-frame periods each including the light-emitting period is 3 msec or more.

In this operation example as well, if the user is going to change the luminance setting, it is possible to change the luminance setting by the same method as that described above with reference to FIG. 5 or 6. If the user is going to make the luminance high, a method of increasing the intensity (potential) of the light emission pulse of the luminance signal, a method of lengthening the light-emitting period of the sub-frame period (increasing the duty ratio), a method of decreasing the number of sub-frame periods in which the non-light-emitting state is set, and the like are considered. These methods may be used in combination. If the user is going to make the luminance low, a method of decreasing the intensity (potential) of the light emission pulse of the luminance signal, a method of shortening the light-emitting period of the sub-frame period (decreasing the duty ratio), a method of increasing the number of sub-frame periods in which the non-light-emitting state is set, and the like are considered. These methods may be used in combination. Thus, it is possible to set the luminance to almost any luminance value.

Next, a further modification of the above-described embodiment will be described. In this embodiment, as shown in FIG. 14, a sub-frame period including a light-emitting period among a plurality of sub-frame periods includes, as non-light-emitting periods, the first non-light-emitting period and the second non-light-emitting period before and after the light-emitting period. The controller 20 can control the driver 50 such that in the sub-frame period including the light-emitting period among the plurality of sub-frame periods, the sub-frame period starts with the first non-light-emitting period, ends with the second non-light-emitting period, and includes the light-emitting period between the first non-light-emitting period and the second non-light-emitting period. Furthermore, the controller 20 can control the driver 50 such that in each unit frame period, the non-light-emitting state is set in at least one of the first sub-frame period and the last sub-frame period. As shown in FIG. 14, the controller 20 may control the driver 50 such that in each unit frame period, the non-light-emitting state is set in the first sub-frame period and the last sub-frame period. If one unit frame period includes a plurality of sub-frame periods each including a light-emitting period, the controller 20 may control the driver 50 such that each unit frame period continuously includes a plurality of sub-frame periods each including a light-emitting period, as shown in FIG. 14. In other words, the controller 20 may control the driver 50 such that each unit frame period includes, between the sub-frame periods each including the light-emitting period, no sub-frame period without the light-emitting period.

The controller 20 (the TG 30 or the light emission pulse generator 33 in another viewpoint) can generate the light emission control signal 21 such that one unit frame period of image data is divided into a plurality of (in other words, n) sub-frame periods. Each of the plurality of sub-frame periods may be a period obtained by temporally evenly dividing one unit frame period. The first non-light-emitting period, the light-emitting period, and the second non-light-emitting period of sub-frame period 1 that is the first sub-frame period are expressed as t_{D1,1}, t_{L1}, and t_{D1,2}, respectively. Similarly, the first non-light-emitting period, the light-emitting period, and the second non-light-emitting period of the kth (k is an integer, 1≤k≤n) sub-frame period k is expressed as t_{Dk,1}, t_{Lk}, and t_{Dk,2}, respectively. If one unit frame period is temporally evenly divided into a plurality of sub-frame periods, t_{D1,1}+t_{L1}+t_{D1,2}=t_{D2,1}+t_{L2}+t_{D2,2}= . . . =t_{Dn,1}+t_{Ln}+t_{Dn,2}. Furthermore, in this embodiment, at least the light-emitting period of first sub-frame period 1 is t_{L1}=0 or the light-emitting period of the last sub-frame period n is tin=0. However, depending on the relationship between the timing setting of image data displayed by the display device 10 and the number n of divisions of one unit frame period (the total number of sub-frame periods), it may be difficult to completely evenly divide one unit frame period (set t_{D1,1}+t_{L1}+t_{D1,2}=t_{D2,1}+t_{L2}+t_{D2,2}= . . . =t_{Dn+1}+t_{Ln}+t_{Dn,2}). However, in the sub-frame period obtained by evenly dividing one unit frame period, control by the controller 20 can be simplified more.

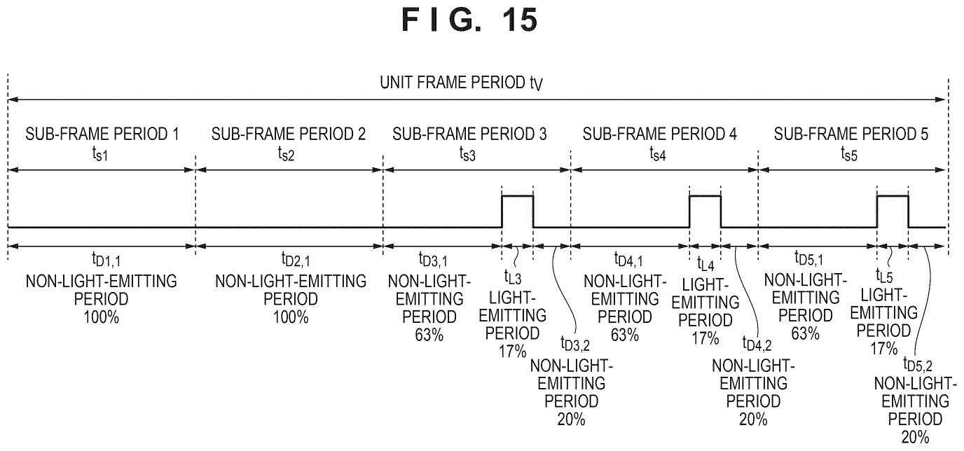

Next, the operation of display device 10 according to this embodiment will exemplarily be described. In this operation example, the refresh rate of the display device 10 is set to 60 Hz. Furthermore, in this operation example, as shown in FIG. 15, one unit frame period of image data of 60 fps is formed by five sub-frame periods. In this operation example, the controller 20 (light emission controller 31) controls the driver 50 (vertical scanning circuit 13) such that in the sub-frame period including the light-emitting period, the sub-frame period starts with the first non-light-emitting period, ends with the second non-light-emitting period, and includes the light-emitting period between the first non-light-emitting period and the second non-light-emitting period. In the example shown in FIG. 15, first sub-frame period 1 and sub-frame period 2 are sub-frame periods in which the non-light-emitting state with a duty ratio of 0% is set (no light-emitting period is included). Sub-frame periods from sub-frame period 3 to last sub-frame period 5 each include the light-emitting period.

As shown in FIG. 14, in a case where each unit frame period is divided into n sub-frame periods where n is 3 or more, and the non-light-emitting state is set in the first sub-frame period, the non-light-emitting state is set in the sub-frame periods from sub-frame period 1 to a sub-frame period p where 1≤p≤n. Therefore, t_{Dini}=tₛ₁+ . . . tₛₚ+t_{Dp+1,1} is satisfied where t_{Dini} represents the length of the first non-light-emitting period in each unit frame period, and tₛₖ represents the length of the sub-frame period k. For p=n−1, the light-emitting period is tin of the sub-frame period n (t_{L1}= . . . =t_{Ln-1}=0), and it may thus be inappropriate to constantly set p=n−1 from the viewpoint of suppression of a flicker. However, as described above, p=n−1 may be temporarily set for the purpose of adjusting the luminance or the like. When p is n−2 or less, t_{Dr′,2}+t_{Dr′+1,1}<t_{Dini} (r′ is an integer, p+1≤r≤n−1) may be satisfied in order to improve the blur suppression effect. In other words, the longest non-light-emitting period in each unit frame period is set to the beginning of the unit frame period. That is, the controller 20 controls the driver 50 such that in each unit frame period, the length from the start of the unit frame period to the start of the light-emitting period in the first sub-frame period among the sub-frame periods each including the light-emitting period is longer than the length of the non-light-emitting period in each sub-frame period including the light-emitting period. Thus, the period to change the display image data between two continuous unit frame periods becomes long, thereby making it possible to improve the blur suppression effect. In this case, as described above, the controller 20 may control the driver 50 such that in each unit frame period, the length from the start of the unit frame period to the start of the light-emitting period in the first sub-frame period among the sub-frame periods each including the light-emitting period is 3 msec or more.

Furthermore, the first non-light-emitting period of the unit frame period of interest is the non-light-emitting period continuing from the second non-light-emitting period of at least the last sub-frame period n of the immediately preceding unit frame period. Thus, the controller 20 may control the driver 50 such that in each unit frame period, the length from the end of the light-emitting period in the last sub-frame period including the light-emitting period in the immediately preceding unit frame period of the unit frame period to the start of the light-emitting period in the first sub-frame period among the sub-frame periods each including the light-emitting period of the unit frame period is longer than the length of the non-light-emitting period in each sub-frame period including the light-emitting period. Similarly, the controller 20 may control the driver 50 such that in each unit frame period, the length from the end of the light-emitting period in the last sub-frame period including the light-emitting period in the immediately preceding unit frame period of the unit frame period to the start of the light-emitting period in the first sub-frame period among the sub-frame periods each including the light-emitting period of the unit frame period is 3 msec or more.

Similarly, if the non-light-emitting state is set in the last sub-frame period, the non-light-emitting state is set in the sub-frame periods from a sub-frame period q to the sub-frame period n (the last sub-frame period) where 2≤q≤n. Therefore, t_{Dend}=t_{Dq-1,2}+t_{sq}+ . . . tₛₙ is satisfied where t_{Dend} represents the length of the last non-light-emitting period in each unit frame period, and tₛₖ represents the length of the sub-frame period k. For m=2, the light-emitting period is t_{L1} of sub-frame period 1 (t_{L2}= . . . =t_{Ln}=0), and it may thus be inappropriate to constantly set q=2 from the viewpoint of suppression of a flicker. However, as described above, q=2 may be temporarily set for the purpose of adjusting the luminance or the like. When q is 3 or more, t_{Dr′,2}+t_{Dr′+1,1}<t_{Dend} (r′ is an integer, 1≤r≤m−2) may be satisfied in order to improve the blur suppression effect. In other words, the longest non-light-emitting period in each unit frame period is set to the end of the unit frame period. That is, the controller 20 controls the driver 50 such that in each unit frame period, the length from the end of the light-emitting period in the last sub-frame period among the sub-frame periods each including the light-emitting period to the end of the unit frame period is longer than the length of the non-light-emitting period in each sub-frame period including the light-emitting period. Thus, as described above, the period to change the display image data between two continuous unit frame periods becomes long, thereby making it possible to improve the blur suppression effect. In this case, as described above, the controller 20 may control the driver 50 such that in each unit frame period, the length from the end of the light-emitting period in the last sub-frame period among the sub-frame periods each including the light-emitting period to the end of the unit frame period is 3 msec or more.

Furthermore, the last non-light-emitting period of the unit frame period of interest is the non-light-emitting period continuing to the first non-light-emitting period of at least first sub-frame period 1 of the immediately succeeding unit frame period. Therefore, as described above, the controller 20 may control the driver 50 such that in each unit frame period, the length from the end of the light-emitting period in the last sub-frame period including the light-emitting period in the immediately preceding unit frame period of the unit frame period to the start of the light-emitting period in the first sub-frame period among the sub-frame periods each including the light-emitting period of the unit frame period is longer than the length of the non-light-emitting period in each sub-frame period including the light-emitting period. Similarly, the controller 20 may control the driver 50 such that in each unit frame period, the length from the end of the light-emitting period in the last sub-frame period including the light-emitting period in the immediately preceding unit frame period of the unit frame period to the start of the light-emitting period in the first sub-frame period among the sub-frame periods each including the light-emitting period of the unit frame period is 3 msec or more.

When t_{V} represents one unit frame period, in this operation example shown in FIG. 15, p=2 and n=5, thereby satisfying t_{Dini}=t_{D5,2}+tₛ₁+tₛ₂+t_{D3,1} in consideration of the immediately preceding unit frame period. Since t_{D3,2}+t_{D4,1}=t_{D4,2}+t_{D5,1}, t_{Dr′,2}+t_{Dr′+1,1}<t_{Dini} (r′=4, 5) is satisfied. In this embodiment, t_{Dini}=9.4 msec is obtained.

As described above, the controller 20 (light emission controller 31) controls the driver 50 (vertical scanning circuit 13) such that in each unit frame period, the duty ratio of at least the first sub-frame period or the last sub-frame period is 0%. Since each unit frame period is divided into five sub-frame periods with a refresh rate of 60 Hz, the apparent refresh rate is 300 Hz. In driving at 300 Hz, flickers are hardly visually recognized, and it can thus be said in this operation example that flickers are suppressed. If driving is performed at a duty ratio of 17% in all the sub-frame periods, the non-light-emitting period immediately after switching to the current unit frame period (for example, switching of the display image data) is 2.8 msec. In contrast, in this operation example, the non-light-emitting period immediately after switching to the current unit frame period is as long as 9.4 msec. When the non-light-emitting period immediately after switching of the display image data is long, it is possible to suppress a blur caused by averaging the videos by the after image effect of human vision.

In this operation example as well, if the user is going to change the luminance setting, it is possible to change the luminance setting by the same method as that described above with reference to FIG. 5 or 6. If the user is going to make the luminance high, a method of increasing the intensity (potential) of the light emission pulse of the luminance signal, a method of lengthening the light-emitting period of the sub-frame period (increasing the duty ratio), a method of decreasing the number of sub-frame periods in which the non-light-emitting state is set, and the like are considered. These methods may be used in combination. If the user is going to make the luminance low, a method of decreasing the intensity (potential) of the light emission pulse of the luminance signal, a method of shortening the light-emitting period of the sub-frame period (decreasing the duty ratio), a method of increasing the number of sub-frame periods in which the non-light-emitting state is set, and the like are considered. These methods may be used in combination. Thus, it is possible to set the luminance to almost any luminance value.

The display device 10 according to each of the above-described embodiments can divide one unit frame period into a plurality of sub-frame periods, and adjust the duty ratios of light emission or non-light emission in the plurality of sub-frame periods. Therefore, the degree of freedom of effective luminance adjustment is improved. The luminance level setting unit 32 may set the luminance level based on image data. More specifically, the luminance level setting unit 32 may calculate the luminance of entire image data, and set the luminance level based on the luminance of the entire image data (that is, supply the luminance level to the light emission pulse generator 33).

The display device 10, a display apparatus including the display device 10, or the like may include a measurement device 70 that includes a sensor for measuring the luminance on the periphery of the display device 10. If the display device 10 includes the measurement device 70, the measurement device 70 may be arranged on the periphery of the pixel array 12, as shown in FIG. 1, and measure the luminance on the periphery of the pixel array 12 and the like. The measurement device 70 may be separated from the display device 10. The controller 20 may decide the duty ratio in each sub-frame period including the light-emitting period in accordance with the output of the measurement device 70 (luminance information measured by the measurement device). When the display device 10 includes the measurement device 70, it is possible to improve immediacy of luminance adjustment. If the time from obtaining of information indicating an ambient luminance to adjustment of the luminance is long, followability to an abrupt change of the ambient luminance (for example, in a case where a car enters a tunnel and exits from there or a case where a lighting is turned on/off indoors) is low. To improve user usability, in one embodiment, immediacy of luminance adjustment is set to be high. The controller 20 decides the duty ratio according to the ambient luminance information obtained by the measurement device 70. If the luminance information obtained by the measurement device 70 in each unit frame period changes, with respect to the sub-frame period including the light-emitting period among the plurality of sub-frame periods, the controller 20 changes the duty ratio in the sub-frame period. For example, when the unit frame period starts, the luminance level is set based on image data. After that, if the luminance information changes, the duty ratio is changed even within one unit frame period, and the luminance level is adjusted. Thus, the followability to an abrupt change of the ambient luminance of the display device 10 is improved.

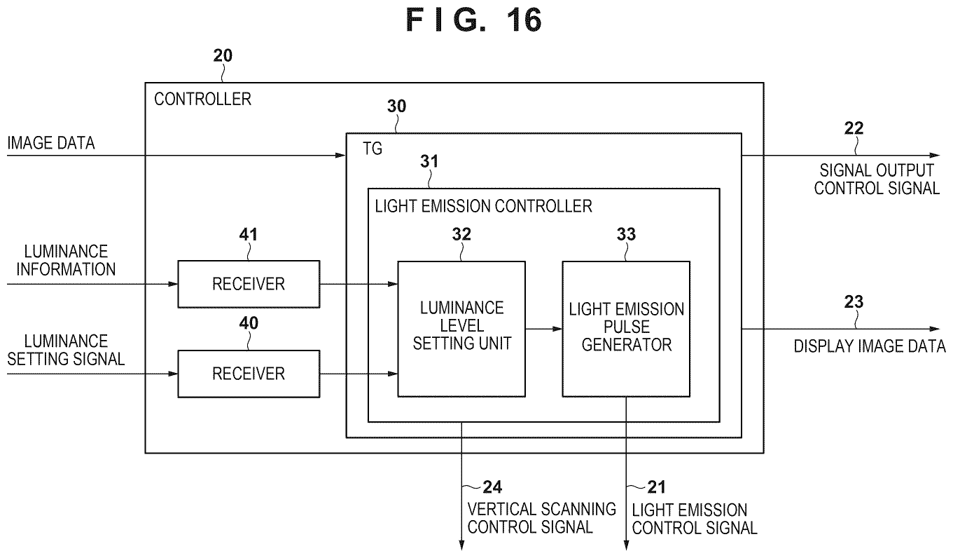

FIG. 16 shows the configuration in which the controller 20 receives the ambient luminance information from the measurement device 70 in a case where the display device 10 includes the measurement device 70 that measures the ambient luminance. The controller 20 includes a receiver 41 that receives the luminance information from the measurement device 70, and supplies a signal based on the luminance information to the light emission controller 31. The light emission controller 31 sets the luminance level in accordance with the supplied signal based on the luminance information separately from the luminance setting information provided from the receiver 40 that receives the luminance setting information. If the luminance setting information is provided from the receiver 40 and the ambient luminance information is provided from the receiver 41, the luminance level setting unit 32 can set the luminance level based on both the pieces of information.

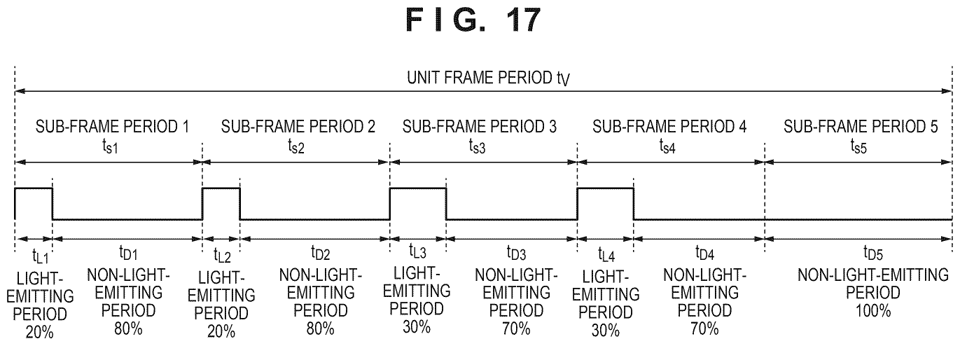

FIG. 17 shows an example of the operation of the display device 10 that changes the luminance based on the luminance information obtained by the measurement device 70. In the operation example shown in FIG. 17, an example in which the controller 20 (light emission controller 31 (luminance level setting unit 32)) increases the luminance level (increases the brightness of the display image) in accordance with the luminance information is shown. With respect to operation example 1-1 described above, the controller 20 (luminance level setting unit 32) processes the luminance information supplied from the measurement device 70, and decides to make the luminance level high before the end of sub-frame period 2. In this operation example, the controller 20 (light emission pulse generator 33) changes the duty ratios of light emission or non-light emission in sub-frame periods 3 and 4 in accordance with the luminance level setting. After the change, t_{Dend}=9.2 msec is obtained. Therefore, t_{Dend}≥3 msec is also satisfied. Thus, even in a case where luminance adjustment is performed, the display device 10 according to this embodiment can suppress both a flicker and a blur.

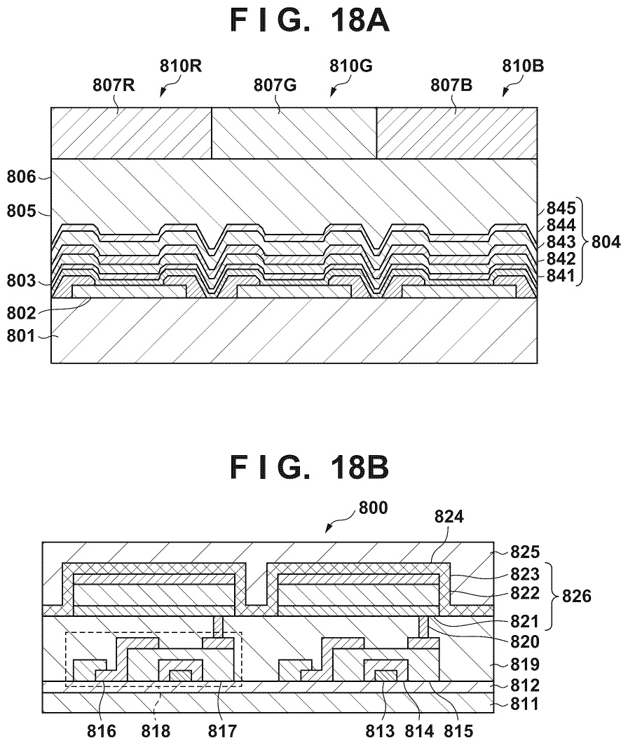

Here, application examples in which the display device 10 according to this embodiment is applied to an image forming apparatus, a display apparatus, a photoelectric conversion apparatus, an electronic apparatus, an illumination apparatus, a moving body, and a wearable device will be described with reference to FIGS. 18A to 26B. The description will be given assuming that, for example, an organic light-emitting element (OLED) such as an organic EL element using an organic light-emitting material is arranged in the pixel 11 arranged in the display device 10. Details of each component arranged in the pixel 11 of the display device 10 described above will be described first, and the application examples will be described after that.

FIG. 18A shows an example of the pixel arranged in the display device 10. The pixel includes sub-pixels 810. The sub-pixels 810 can correspond to the above-described pixel 11. The sub-pixels 810 are divided into sub-pixels 810R, 810G, and 810B by light emission colors. The light emission colors may be discriminated by the wavelengths of light components emitted from the light-emitting layers, or light emitted from each sub-pixel may be selectively transmitted or undergo color conversion by a color filter or the like. Each sub-pixel includes a reflective electrode 802 as the first electrode on an interlayer insulating layer 801, an insulating layer 803 covering the end of the reflective electrode 802, an organic compound layer 804 covering the first electrode and the insulating layer, a transparent electrode 805 as the second electrode, a protection layer 806, and a color filter 807.

The interlayer insulating layer 801 can include a transistor and a capacitive element arranged in the interlayer insulating layer 801 or a layer below it. The transistor and the first electrode can electrically be connected via a contact hole (not shown) or the like.

The insulating layer 803 can also be called a bank or a pixel isolation film. The insulating layer 803 covers the end of the first electrode, and is arranged to surround the first electrode. A portion of the first electrode where no insulating layer 803 is arranged is in contact with the organic compound layer 804 to form a light-emitting region.

The organic compound layer 804 includes a hole injection layer 841, a hole transport layer 842, a first light-emitting layer 843, a second light-emitting layer 844, and an electron transport layer 845.

The second electrode may be a transparent electrode, a reflective electrode, or a semi-transmissive electrode.

The protection layer 806 suppresses permeation of water into the organic compound layer. The protection layer is shown as a single layer but may include a plurality of layers. Each layer can be an inorganic compound layer or an organic compound layer.

The color filter 807 is divided into color filters 807R, 807G, and 807B by colors. The color filters can be formed on a planarizing film (not shown). A resin protection layer (not shown) may be arranged on the color filters. The color filters can be formed on the protection layer 806. Alternatively, the color filters can be provided on the counter substrate such as a glass substrate, and then the substrate may be bonded.

A display apparatus 800 (corresponding to the display device 10 described above) shown in FIG. 18B is provided with an organic light-emitting element 826 as an example of a light-emitting element and a TFT 818 as an example of a transistor. A substrate 811 of glass, silicon, or the like is provided and an insulating layer 812 is provided on the substrate 811. The active element such as the TFT 818 is arranged on the insulating layer, and a gate electrode 813, a gate insulating film 814, and a semiconductor layer 815 of the active element are arranged. The TFT 818 further includes the semiconductor layer 815, a drain electrode 816, and a source electrode 817. An insulating film 819 is provided on the TFT 818. The source electrode 817 and an anode 821 forming the organic light-emitting element 826 are connected via a contact hole 820 formed in the insulating film.

A method of electrically connecting the electrodes (anode and cathode) included in the organic light-emitting element 826 and the electrodes (source electrode and drain electrode) included in the TFT is not limited to that shown in FIG. 18B. That is, one of the anode and cathode and one of the source electrode and drain electrode of the TFT are electrically connected. The TFT indicates a thin-film transistor.

In the display apparatus 800 shown in FIG. 18B, an organic compound layer is illustrated as one layer. However, an organic compound layer 822 may include a plurality of layers. A first protection layer 824 and a second protection layer 825 are provided on a cathode 823 to suppress deterioration of the organic light-emitting element.

A transistor is used as a switching element in the display apparatus 800 shown in FIG. 18B, but another switching element may be used instead.

The transistor used in the display apparatus 800 shown in FIG. 18B is not limited to a transistor using a single-crystal silicon wafer, and may be a thin-film transistor including an active layer on an insulating surface of a substrate. Examples of the active layer include single-crystal silicon, amorphous silicon, non-single-crystal silicon such as microcrystalline silicon, and a non-single-crystal oxide semiconductor such as indium zinc oxide and indium gallium zinc oxide. Note that a thin-film transistor is also called a TFT element.

The transistor included in the display apparatus 800 shown in FIG. 18B may be formed in the substrate such as a silicon substrate. Forming the transistor in the substrate means forming the transistor by processing the substrate such as a silicon substrate. That is, when the transistor is included in the substrate, it can be considered that the substrate and the transistor are formed integrally.

The light emission luminance of the organic light-emitting element according to this embodiment can be controlled by the TFT which is an example of a switching element, and a plurality of organic light-emitting elements can be provided in a plane to display an image with the light emission luminances of the respective elements. Here, the switching element according to this embodiment is not limited to the TFT, and may be a transistor formed from low-temperature polysilicon or an active matrix driver formed on the substrate such as a silicon substrate. The term “on the substrate” may mean “in the substrate”. Whether to provide a transistor in the substrate or use a TFT is selected based on the size of the display. For example, if the size is about 0.5 inch, the organic light-emitting element may be provided on the silicon substrate.

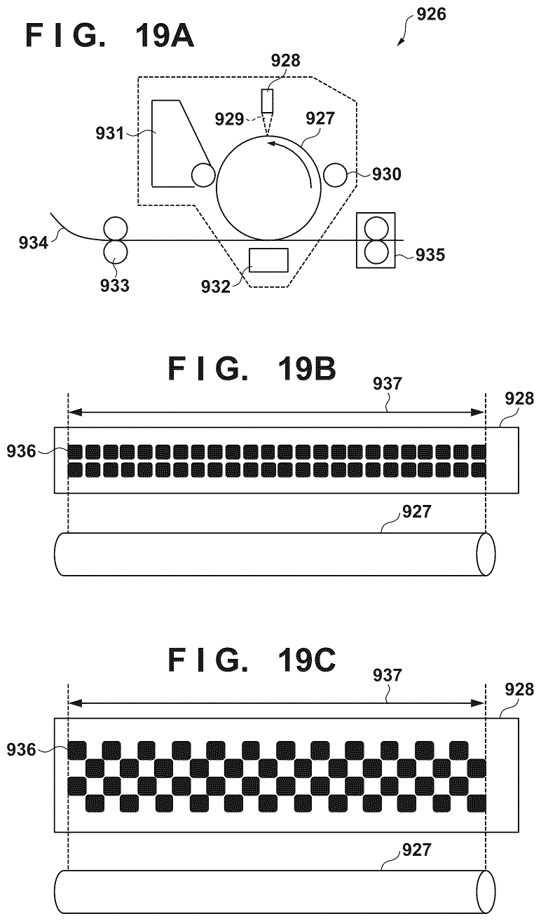

FIGS. 19A to 19C are schematic views showing an example of an image forming apparatus using the display device 10 according to this embodiment. An image forming apparatus 926 shown in FIG. 19A includes a photosensitive member 927, an exposure light source 928, a developing unit 931, a charging unit 930, a transfer device 932, a conveyance unit 933 (a conveyance roller in the configuration shown in FIG. 19A), and a fixing device 935.

Light 929 is emitted from the exposure light source 928, and an electrostatic latent image is formed on the surface of the photosensitive member 927. The display device 10 can be applied to the exposure light source 928. The developing unit 931 can function as a developing device that includes a toner or the like as a developing agent and applies the developing agent to the exposed photosensitive member 927. The charging unit 930 charges the photosensitive member 927. The transfer device 932 transfers the developed image to a print medium 934. The conveyance unit 933 conveys the print medium 934. The print medium 934 can be, for example, paper, a film, or the like. The fixing device 935 fixes the image formed on the print medium.

Each of FIGS. 19B and 19C is a schematic view showing a form in which a plurality of light-emitting units 936 are arranged in the exposure light source 928 along the longitudinal direction of a long substrate. The display device 10 can be applied to each of the light-emitting units 936. That is, the plurality of pixels 11 are arranged along the longitudinal direction of the substrate. A direction 937 is a direction parallel to the axis of the photosensitive member 927. This column direction matches the direction of the axis upon rotating the photosensitive member 927. This direction 937 can also be referred to as the long-axis direction of the photosensitive member 927.

FIG. 19B shows a form in which the light-emitting units 936 are arranged along the long-axis direction of the photosensitive member 927. FIG. 19C shows a form, which is a modification of the arrangement of the light-emitting units 936 shown in FIG. 19B, in which the light-emitting units 936 are arranged in the column direction alternately between the first column and the second column. The light-emitting units 936 are arranged at different positions in the row direction between the first column and the second column. In the first column, a plurality of light-emitting units 936 are arranged apart from each other. In the second column, the light-emitting unit 936 is arranged at the position corresponding to the space between the light-emitting units 936 in the first column. Furthermore, in the row direction, a plurality of light-emitting units 936 are arranged apart from each other. The arrangement of the light-emitting units 936 shown in FIG. 19C can be referred to as, for example, an arrangement in a grid pattern, an arrangement in a staggered pattern, or an arrangement in a checkered pattern.

FIG. 20 is a schematic view showing an example of the display apparatus using the display device 10 according to this embodiment. A display apparatus 1000 can include a touch panel 1003, a display panel 1005, a frame 1006, a circuit board 1007, and a battery 1008 between an upper cover 1001 and a lower cover 1009. Flexible printed circuits (FPCs) 1002 and 1004 are respectively connected to the touch panel 1003 and the display panel 1005. Active elements such as transistors are arranged on the circuit board 1007. The battery 1008 is unnecessary if the display apparatus 1000 is not a portable apparatus. Even when the display apparatus 1000 is a portable apparatus, the battery 1008 need not be provided at this position. The display device 10 can be applied to the display panel 1005. The pixels 11 arranged in the display device 10 functioning as the display panel 1005 are connected to the control circuit including the active elements such as the transistors arranged on the circuit board 1007 and operate.

The display apparatus 1000 shown in FIG. 20 can be used for a display of a photoelectric conversion apparatus (also referred to as an image capturing apparatus) including an optical system having a plurality of lenses, and an image sensor for receiving light having passed through the optical system and photoelectrically converting the light into an electrical signal. The photoelectric conversion apparatus can include a display for displaying information acquired by the image sensor. In addition, the display can be either a display exposed outside the photoelectric conversion apparatus, or a display arranged in the finder. The photoelectric conversion apparatus can be a digital camera or a digital video camera.

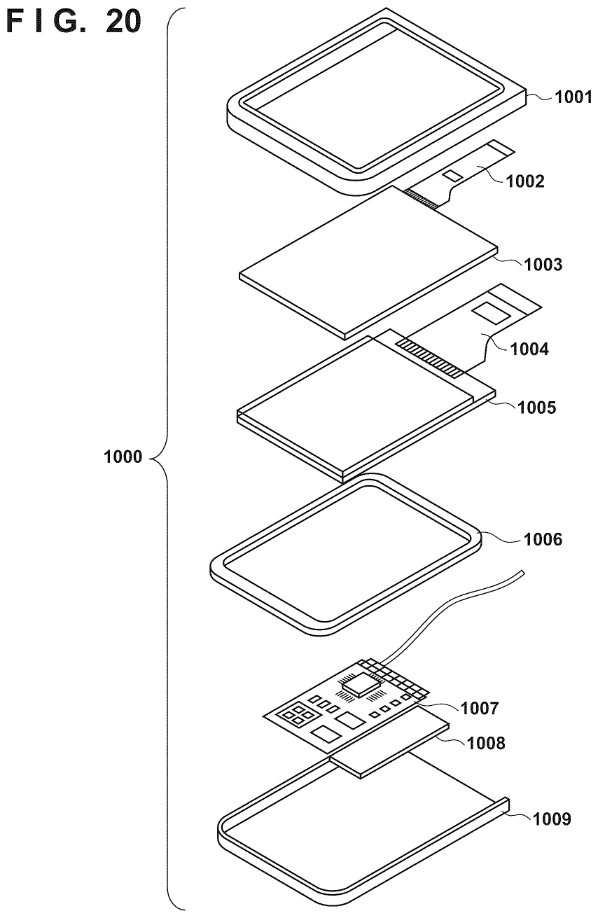

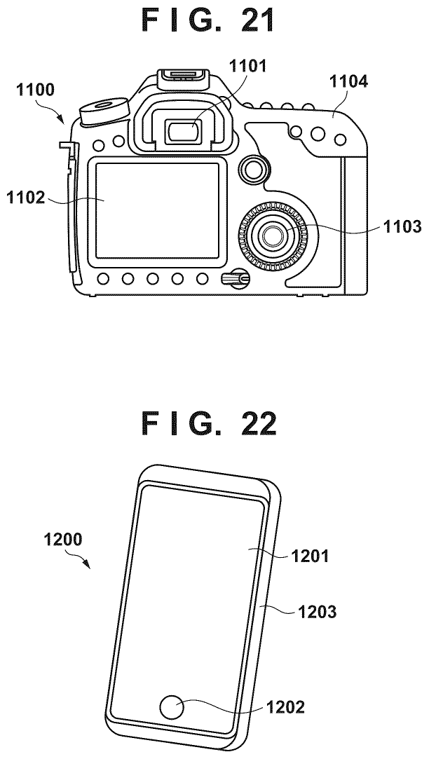

FIG. 21 is a schematic view showing an example of the photoelectric conversion apparatus using the display device 10 according to this embodiment. A photoelectric conversion apparatus 1100 can include a viewfinder 1101, a rear display 1102, an operation unit 1103, and a housing 1104. The photoelectric conversion apparatus 1100 can also be called an image capturing apparatus. The display device 10 according to this embodiment can be applied to the viewfinder 1101 or the rear display 1102 as a display. In this case, the display device 10 can display not only an image to be captured but also environment information, image capturing instructions, and the like. Examples of the environment information are the intensity and direction of external light, the moving velocity of an object, and the possibility that an object is covered with an obstacle.

The timing suitable for image capturing is a very short time in many cases, it is better to display the information as soon as possible. Therefore, the display device 10 in which the pixel 11 including the light-emitting element using the organic light-emitting material such as an organic EL element is arranged may be used for the viewfinder 1101 or the rear display 1102. This is so because the organic light-emitting material has a high response speed. In one embodiment, the display device 10 using the organic light-emitting material can be used for the apparatuses that require a high display speed more suitably than for the liquid crystal display apparatus.

The photoelectric conversion apparatus 1100 includes an optical system (not shown). This optical system has a plurality of lenses, and forms an image on a photoelectric conversion element (not shown) that receives light having passed through the optical system and is accommodated in the housing 1104. The focal points of the plurality of lenses can be adjusted by adjusting the relative positions. This operation can also automatically be performed.

The display device 10 may be applied to a display of an electronic apparatus. At this time, the display can have both a display function and an operation function. Examples of the portable terminal are a portable phone such as a smartphone, a tablet, and a head mounted display.

FIG. 22 is a schematic view showing an example of an electronic apparatus using the display device 10 according to this embodiment. An electronic apparatus 1200 includes a display 1201, an operation unit 1202, and a housing 1203. The housing 1203 can accommodate a circuit, a printed board having this circuit, a battery, and a communication device. The operation unit 1202 can be a button or a touch-panel-type reaction unit. The operation unit 1202 can also be a biometric authentication unit that performs unlocking or the like by authenticating the fingerprint. The portable equipment including the communication device can also be regarded as communication equipment. The display device 10 according to this embodiment can be applied to the display 1201.

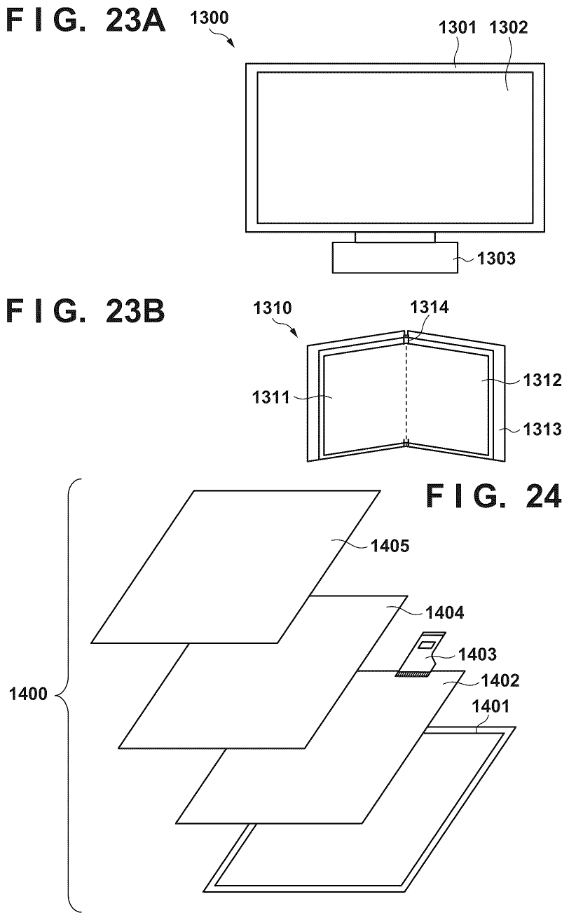

FIGS. 23A and 23B are schematic views showing examples of the display apparatus using the display device 10 according to this embodiment. FIG. 23A shows a display apparatus such as a television monitor or a PC monitor. A display apparatus 1300 includes a frame 1301 and a display 1302. The display device 10 according to this embodiment can be applied to the display 1302. The display apparatus 1300 can include a base 1303 that supports the frame 1301 and the display 1302. The base 1303 is not limited to the form shown in FIG. 23A. For example, the lower side of the frame 1301 may also function as the base 1303. In addition, the frame 1301 and the display 1302 can be bent. The radius of curvature in this case can be 5,000 mm (inclusive) to 6,000 mm (inclusive).

FIG. 23B is a schematic view showing another example of the display apparatus using the display device 10 according to this embodiment. A display apparatus 1310 shown in FIG. 23B can be folded, and is a so-called foldable display apparatus. The display apparatus 1310 includes a first display 1311, a second display 1312, a housing 1313, and a bending point 1314. The display device 10 according to this embodiment can be applied to each of the first display 1311 and the second display 1312. The first display 1311 and the second display 1312 can also be one seamless display apparatus. The first display 1311 and the second display 1312 can be divided by the bending point. The first display 1311 and the second display 1312 can display different images, and can also display one image together.

FIG. 24 is a schematic view showing an example of the illumination apparatus using the display device 10 according to this embodiment. An illumination apparatus 1400 can include a housing 1401, a light source 1402, a circuit board 1403, an optical film 1404, and a light diffusing unit 1405. The display device 10 according to this embodiment can be applied to the light source 1402. The optical film 1404 can be a filter that improves the color rendering of the light source. When performing lighting-up or the like, the light diffusing unit 1405 can throw the light of the light source over a broad range by effectively diffusing the light. The illumination apparatus can also include a cover on the outermost portion, as needed. The illumination apparatus 1400 can include both or one of the optical film 1404 and the light diffusing unit 1405.

The illumination apparatus 1400 is, for example, an apparatus for illuminating the interior of the room. The illumination apparatus 1400 can emit white light, natural white light, or light of any color from blue to red. The illumination apparatus 1400 can also include a light control circuit for controlling these light components. The illumination apparatus 1400 can also include a power supply circuit connected to the display device 10 functioning as the light source 1402. The power supply circuit is a circuit for converting an AC voltage into a DC voltage. White has a color temperature of 4,200 K, and natural white has a color temperature of 5,000 K. The illumination apparatus 1400 may also include a color filter. In addition, the illumination apparatus 1400 can include a heat radiation unit. The heat radiation unit radiates the internal heat of the apparatus to the outside of the apparatus, and examples are a metal having a high specific heat and liquid silicon.

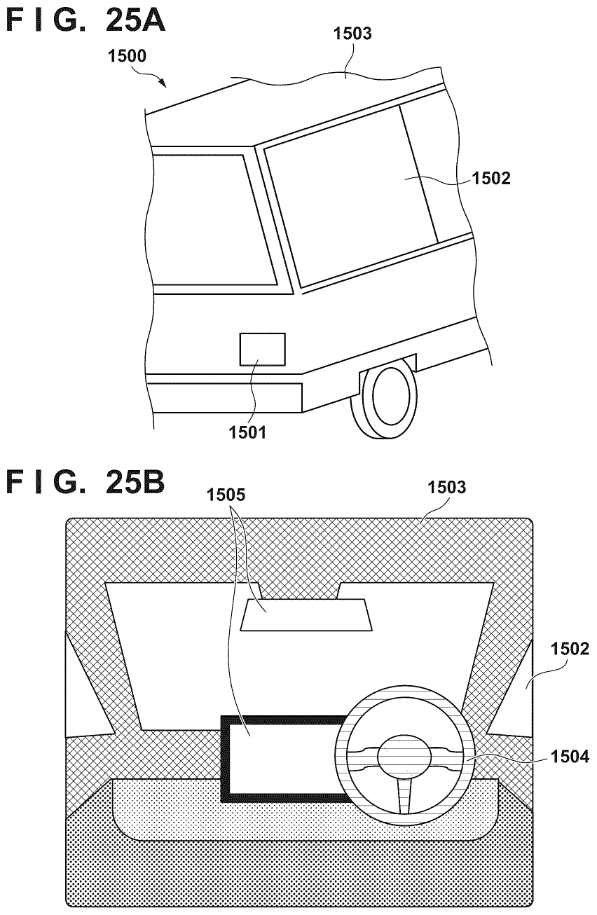

FIG. 25A is a schematic view of an automobile having a taillight as an example of a vehicle lighting appliance using the display device 10 according to this embodiment. An automobile 1500 has a taillight 1501, and can have a form in which the taillight 1501 is turned on when performing a braking operation or the like. The display device 10 according to this embodiment can be used as a headlight serving as a vehicle lighting appliance.

The display device 10 according to this embodiment can be applied to the taillight 1501. The taillight 1501 can include a protection member for protecting the display device 10 functioning as the taillight 1501. The material of the protection member is not limited as long as the material is a transparent material with a strength that is high to some extent, and an example is polycarbonate. The protection member may be made of a material obtained by mixing a furandicarboxylic acid derivative, an acrylonitrile derivative, or the like in polycarbonate.

The automobile 1500 can include a vehicle body 1503, and a window 1502 attached to the vehicle body 1503. This window can be a window for checking the front and back of the automobile, and can also be a transparent display such as a head-up display. For this transparent display, the display device 10 according to this embodiment may be used. In this case, the constituent materials of the electrodes and the like of the display device 10 are formed by transparent members.

In addition, as shown in FIG. 25B, the automobile 1500 can include a steering wheel 1504 that controls the moving direction of the moving body (automobile), and a display 1505 that is mounted on the vehicle body 1503 and displays the state of the moving body such as a speed, a map, the position of the moving body, a turning direction, the visual field on the rear side of the moving body, and the like. The display device 10 according to this embodiment can be applied to the display 1505.

The automobile 1500 is an example of the moving body, and the moving body according to this embodiment includes one or both of a driving force generator that generates a driving force mainly used for moving the moving body and a rotating body mainly used for moving the moving body. The driving force generator can be an engine, a motor, or the like. The rotating body can be a tire, a wheel, a ship screw, an aircraft propeller or fan, or the like. More specifically, the moving body may be a bicycle, an automobile, a train, a ship, an aircraft, a drone, or the like. The moving body may include a main body and a lighting appliance provided in the main body. The lighting appliance may be used to make a notification of the current position of the main body. The lighting appliance may include the display device 10 according to this embodiment. The display may include the display device 10 according to this embodiment.

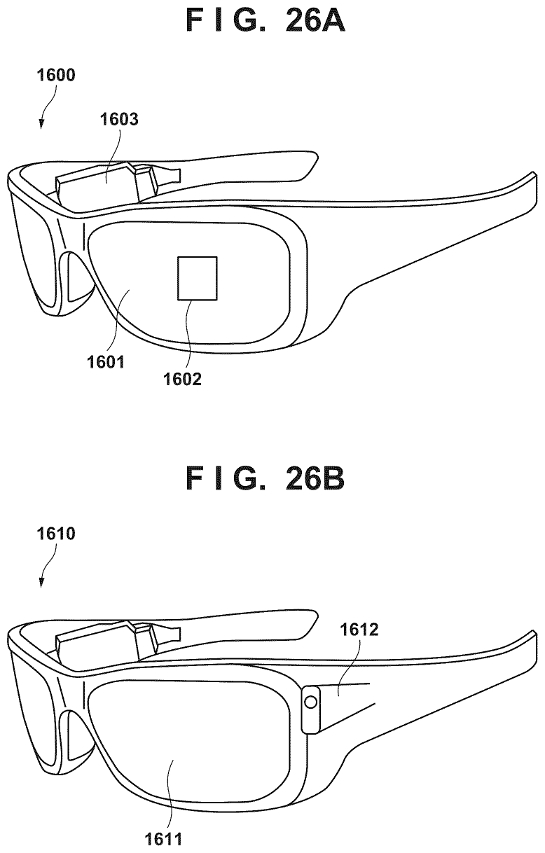

Glasses 1600 (smartglasses) according to one application example will be described with reference to FIG. 26A. An image capturing apparatus 1602 such as a CMOS sensor or an SPAD is provided on the surface side of a lens 1601 of the glasses 1600. In addition, the display device 10 according to this embodiment is provided on the back surface side of the lens 1601.

The glasses 1600 further include a control apparatus 1603. The control apparatus 1603 functions as a power supply that supplies electric power to the image capturing apparatus 1602 and the display device 10 according to each embodiment. In addition, the control apparatus 1603 controls the operations of the image capturing apparatus 1602 and the display device 10. An optical system configured to condense light to the image capturing apparatus 1602 is formed on the lens 1601.

Glasses 1610 (smartglasses) according to one application example will be described with reference to FIG. 26B. The glasses 1610 include a control apparatus 1612, and an image capturing apparatus corresponding to the image capturing apparatus 1602 and the display device 10 are mounted on the control apparatus 1612. The image capturing apparatus in the control apparatus 1612 and an optical system configured to project light emitted from the display device 10 are formed in a lens 1611, and an image is projected to the lens 1611. The control apparatus 1612 functions as a power supply that supplies electric power to the image capturing apparatus and the display device 10, and controls the operations of the image capturing apparatus and the display device 10. The control apparatus 1612 may include a line-of-sight detection unit that detects the line of sight of a wearer. The detection of a line of sight may be done using infrared rays. An infrared ray emitting unit emits infrared rays to an eyeball of the user who is gazing at a displayed image. An image capturing unit including a light-receiving element detects reflected light of the emitted infrared rays from the eyeball, thereby obtaining a captured image of the eyeball. A reduction unit for reducing light from the infrared ray emitting unit to the display in a planar view is provided, thereby reducing deterioration of image quality.

The line of sight of the user to the displayed image is detected from the captured image of the eyeball obtained by capturing the infrared rays. An arbitrary known method can be applied to the line-of-sight detection using the captured image of the eyeball. As an example, a line-of-sight detection method based on a Purkinje image obtained by reflection of irradiation light by a cornea can be used.

More specifically, line-of-sight detection processing based on pupil center corneal reflection is performed. Using pupil center corneal reflection, a line-of-sight vector representing the direction (rotation angle) of the eyeball is calculated based on the image of the pupil and the Purkinje image included in the captured image of the eyeball, thereby detecting the line-of-sight of the user.

The display device 10 according to the embodiment of the disclosure can include an image capturing apparatus including a light-receiving element, and control a displayed image based on the line-of-sight information of the user from the image capturing apparatus.

More specifically, the display device 10 decides a first visual field region at which the user is gazing and a second visual field region other than the first visual field region based on the line-of-sight information. The first visual field region and the second visual field region may be decided by the control apparatus of the display device 10, or those decided by an external control apparatus may be received. In the display region of the display device 10, the display resolution of the first visual field region may be controlled to be higher than the display resolution of the second visual field region. That is, the resolution of the second visual field region may be lower than that of the first visual field region.

In addition, the display region includes a first display region and a second display region different from the first display region, and a region of higher priority is decided from the first display region and the second display region based on line-of-sight information. The first display region and the second display region may be decided by the control apparatus of the display device 10, or those decided by an external control apparatus may be received. The resolution of the region of higher priority may be controlled to be higher than the resolution of the region other than the region of higher priority. That is, the resolution of the region of relatively low priority may be low.

Note that AI may be used to decide the first visual field region or the region of higher priority. The AI may be a model configured to estimate the angle of the line of sight and the distance to a target ahead the line of sight from the image of the eyeball using the image of the eyeball and the direction of actual viewing of the eyeball in the image as supervised data. The AI program may be held by the display device 10, the image capturing apparatus, or an external apparatus. If the external apparatus holds the AI program, it is transmitted to the display device 10 via communication.

When performing display control based on line-of-sight detection, smartglasses further including an image capturing apparatus configured to capture the outside can be applied. The smartglasses can display captured outside information in real time.

According to the disclosure, it is possible to provide a technique advantageous for simultaneously implementing suppression of a flicker and suppression of a blur in a method of diving one frame period into a plurality of sub-frame periods.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

This application claims the benefit of Japanese Patent Application No. 2024-189197, filed Oct. 28, 2024 which is hereby incorporated by reference herein in its entirety.

What is claimed is:

1. A display device comprising:
a pixel array;
a driver configured to drive the pixel array; and
a controller configured to control the driver,
wherein the controller is configured to control the driver such that each of a plurality of unit frame periods includes a plurality of sub-frame periods and a duty ratio in each sub-frame period is controlled, and
in each unit frame period, a non-light-emitting state is set in at least one of an initial sub-frame period and a last sub-frame period.

2. The device according to claim 1, wherein
the controller is further configured to control the driver such that in each unit frame period, the non-light-emitting state is set in the last sub-frame period, and
in a sub-frame period including a light-emitting period among the plurality of sub-frame periods, the sub-frame period starts with the light-emitting period.

3. The device according to claim 2, wherein the controller is further configured to control the driver such that in the sub-frame period including the light-emitting period among the plurality of sub-frame periods, a non-light-emitting period is set after an end of the light-emitting period.

4. The device according to claim 2, wherein
the plurality of sub-frame periods include at least one first sub-frame period each including the light-emitting period and at least one second sub-frame period including the last sub-frame period without the light-emitting period, and
the controller is further configured to control the driver such that each unit frame period includes the at least one second sub-frame period after the at least one first sub-frame period.

5. The device according to claim 4, wherein the controller is further configured to control the driver such that in each unit frame period, a length from an end of the light-emitting period in the last first sub-frame period among the at least one first sub-frame period to an end of the unit frame period is longer than a length of a non-light-emitting period in each of the at least one first sub-frame period.

6. The device according to claim 4, wherein the controller is further configured to control the driver such that in each unit frame period, a length from an end of the light-emitting period in the last first sub-frame period among the at least one first sub-frame period to an end of the unit frame period is not less than 3 msec.

7. The device according to claim 1, wherein
the controller is further configured to control the driver such that in each unit frame period, the non-light-emitting state is set in the initial sub-frame period, and
in a sub-frame period including a light-emitting period among the plurality of sub-frame periods, the sub-frame period starts with a non-light-emitting period.

8. The device according to claim 7, wherein the controller is further configured to control the driver such that in the sub-frame period including the light-emitting period among the plurality of sub-frame periods, the light-emitting period is set after an end of the non-light-emitting period.

9. The device according to claim 7, wherein
the plurality of sub-frame periods include at least one first sub-frame period each including the light-emitting period and at least one second sub-frame period including the initial sub-frame period without the light-emitting period, and
the controller is further configured to control the driver such that each unit frame period includes the at least one first sub-frame period after the at least one second sub-frame period.

10. The device according to claim 9, wherein the controller is further configured to control the driver such that in each unit frame period, a length from a start of the unit frame period to a start of the light-emitting period in the initial first sub-frame period among the at least one first sub-frame period is longer than a length of the non-light-emitting period in each of the at least one first sub-frame period.

11. The device according to claim 9, wherein the controller is further configured to control the driver such that in each unit frame period, a length from a start of the unit frame period to a start of the light-emitting period in the initial first sub-frame period among the at least one first sub-frame period is not less than 3 msec.

12. The device according to claim 1, wherein
a sub-frame period including a light-emitting period among the plurality of sub-frame periods includes a first non-light-emitting period and a second non-light-emitting period as non-light-emitting periods, and
the controller is further configured to control the driver such that in the sub-frame period including the light-emitting period among the plurality of sub-frame periods, the sub-frame period starts with the first non-light-emitting period, ends with the second non-light-emitting period, and includes the light-emitting period between the first non-light-emitting period and the second non-light-emitting period.

13. The device according to claim 12, wherein the controller is further configured to control the driver such that in each unit frame period, a non-light-emitting state is set in the initial sub-frame period and the last sub-frame period.

14. The device according to claim 12, wherein
the plurality of sub-frame periods include at least one first sub-frame period each including the light-emitting period and at least one second sub-frame period without the light-emitting period, and
in a case where the at least one first sub-frame period includes a plurality of first sub-frame periods, the controller is configured to control the driver such that each unit frame period continuously includes the plurality of first sub-frame periods.

15. The device according to claim 14, wherein the controller is further configured to control the driver such that in each unit frame period, a length from an end of the light-emitting period in the last first sub-frame period among the at least one first sub-frame period of an immediately preceding unit frame period of the unit frame period to a start of the light-emitting period in the initial first sub-frame period among the at least one first sub-frame period of the unit frame period is longer than a length of the non-light-emitting period in each of the at least one first sub-frame period.

16. The device according to claim 14, wherein the controller is further configured to control the driver such that in each unit frame period, a length from an end of the light-emitting period in the last first sub-frame period among the at least one first sub-frame period of an immediately preceding unit frame period of the unit frame period to a start of the light-emitting period of the initial first sub-frame period among the at least one first sub-frame period of the unit frame period is not less than 3 msec.

17. The device according to claim 1, wherein the driver is further configured to supply, to each of a plurality of pixels arranged in the pixel array, a luminance signal according to a luminance level.

18. The device according to claim 17, wherein the luminance signal is a signal having a potential according to the luminance level.

19. The device according to claim 17, wherein the driver is further configured to supply the luminance signal to each of the plurality of pixels once in each unit frame period.

20. The device according to claim 19, further comprising a measurement device configured to measure a luminance on a periphery of the display device,
wherein in each unit frame period, the controller is configured to decide a duty ratio in a sub-frame period including a light-emitting period among the plurality of sub-frame periods in accordance with luminance information acquired by the measurement device.

21. The device according to claim 20, wherein in a case where the luminance information changes in each unit frame period, with respect to the sub-frame period including the light-emitting period among the plurality of sub-frame periods, the controller is configured to change the duty ratio in the sub-frame period.

22. The device according to claim 1, wherein each unit frame period includes at least three sub-frame periods as the plurality of sub-frame periods.

23. A display apparatus comprising:
the display device according to claim 1; and
a control circuit connected to the display device.

24. A conversion apparatus comprising:
a system including a plurality of lenses;
a sensor configured to receive light having passed through the system; and
a display configured to display an image,
wherein the display includes the display device according to claim 1.

25. An apparatus comprising:
a housing provided with a display; and
a communication device provided in the housing and configured to perform external communication,
wherein the display includes the display device according to claim 1.

26. A moving body comprising:
a main body; and
a display provided in the main body,
wherein the display includes the display device according to claim 1.

27. A wearable device comprising:
a display apparatus configured to display an image,
wherein the display apparatus includes the display device according to claim 1.
